(19) United States
(12) Patent Application Publication
(10) Pub. No.: US 2017/0017473 A1
(43) Pub. Date: Jan. 19, 2017

(54) OPTIMIZATION DEVICE, OPTIMIZATION PROGRAM AND METHOD FOR GENERATING OF OPTIMIZED PROGRAM

(71) Applicant: FUJITSU LIMITED, Kawasaki-shi (JP)

(72) Inventors: Hideki MATSUOKA, Yokohama (JP); Hirotoshi Shimizu, Yokohama (JP); Yoshiharu Tozawa, Kawasaki (JP)

(73) Assignee: FUJITSU LIMITED, Kawasaki-shi (JP)

(21) Appl. No.: 15/207,680

(22) Filed: Jul. 12, 2016

(30) Foreign Application Priority Data
Jul. 15, 2015 (JP) 2015-141293

(51) Int. Cl. G06F 9/45

(52) U.S. Cl. CPC G06F 8/443

(57) ABSTRACT

An optimization device of a program, the optimization device includes a memory to store a source code; and a processor that detects a structure or an array having a member targeted for access in a loop processing from the source code, inserts a first code declaring a pointer variable and a second code that sets an address of the structure or the array in the pointer variable before the loop processing of the source code, and replaces a code which accesses the member in the loop processing with a third code accessing the member based on the pointer variable.

### CROSS-REFERENCE TO RELATED APPLICATION

This application is based upon and claims the benefit of priority of the prior Japanese Patent Application No. 2015-141293, filed on Jul. 15, 2015, the entire contents of which are incorporated herein by reference.

### FIELD

The embodiments discussed herein are related to an optimization device, an optimization program and a method for generating of an optimized program.

### BACKGROUND

In late years, a size of information system that software (program) works becomes large according to increases of the number of users and functions. According to the large scale of the information system, the performance standard demanded for the software becomes high.

A compiler compiles source program described according to programming languages such as the C language and generates an object code. In addition, the compiler has an optimization function (Option level) that rises the performance of the software. A developer optimizes a source code and the code of assembler using the optimization function, for example. And the performance enhancement of the software is planned by generating the object code based on the source code and the code of assembler which is optimized.

A technique about the optimization of the source code is disclosed in patent documents 1 and 2.

### CITATION LIST

### Patent Document

[patent document 1] Japanese Laid-Open Patent Publication No. 6-75987,

[patent document 2] Japanese National Publication of International Patent application No. 2006-505058.

### SUMMARY

However, a readability of the source code and the code of the assembler that is optimized using the optimization function tends to be low. With a drop of the readability, in case of specifications change or the obstacle correspondence of the software man-hours increase, and the software maintainability decreases.

On the other hand, in order to raise the readability of the source code and the code of the assembler, there is a method to remedy the performance by requesting an election engineer performing a remedy of performance of the software. However, cost and a man-hour produce by requesting the election engineer.

In this way, it is not easy to plan an advance of the performance while considering maintainability of the software.

According to an aspect of the embodiments, an optimization device of a program, the optimization device includes a memory to store a source code, and a processor that detects a structure or an array having a member targeted for access in a loop processing from the source code, inserts a first code declaring a pointer variable and a second code that sets an address of the structure or the array in the pointer variable before the loop processing of the source code, and replaces a code which accesses the member in the loop processing with a third code accessing the member based on the pointer variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram indicating an example of the source code described in the source file “ca” targeted for the optimization.

FIG. 2 is a diagram indicating the constitution of variable “Class [2] [8]” depicted in the source code of FIG. 1.

FIG. 3 is a diagram illustrates an example of the source code after the optimization that the information processing device according to the embodiment optimized the source code depicted in FIG. 1.

FIG. 4 is a diagram of flow chart explaining the optimization processing of source code of the information processing device according to the embodiment.

FIG. 5 is a diagram illustrating a relation of instructions of the program corresponding to the source file “ca” depicted in FIG. 1 with the instructions of the program corresponding to the source file “cb” depicted in FIG. 3.

FIG. 6 is a diagram illustrating the number of the cycles needed for the execution of the program corresponding to the source file “ca” of FIG. 1 and the number of the cycles needed for the execution of the program corresponding to the source file “cb” after the optimization of FIG. 3.

FIG. 7 is a diagram of hardware constitution of the information processing device (optimization device of the program) 100 according to the embodiment.

FIG. 8 is a diagram illustrating constitution of the software block of the compile program 120 depicted in FIG. 7.

FIG. 9 is a diagram of flow chart explaining the details of the processing of compile program 120 that is explained in FIG. 8.

FIG. 10 is a diagram of first flow chart explaining the details of the processing of process S21 which is explained in FIG. 9.

FIG. 11 is a diagram representing an example of loop statement detection table 131.

FIG. 12 is a diagram of second flow chart explaining the processing of process S21 which is explained in FIG. 9.

FIG. 13 is a diagram indicating an example of structure detection table 132.

FIG. 14 is a diagram of flow chart explaining the structure analysis processing of the process S46 which is explained in FIG. 12.

FIG. 15 is a diagram indicating an example of the optimization structure table 133.

FIG. 16 is a diagram of flow chart explaining processing in the process S22 which is explained in FIG. 9.

FIG. 17 is a diagram of flow chart explaining the details of the processing in the process S101 which is explained in FIG. 16.

FIG. 18 is a diagram indicating an example of the changed optimization structure table 134.

FIG. 19 is a diagram of flow chart explaining the details of the processing of process S102 which is explained in FIG. 16.

FIG. 20 is a diagram of flow chart explaining the details of the processing of process S103 which is explained in FIG. 16.

FIG. 21 is a diagram of flow chart explaining the details of the processing of process S104 which is explained in FIG. 16.

FIG. 22 is a diagram indicating the examples of source file ca-1 including the source code for the different optimization target.

FIG. 23 indicates an example of the source file cb-1 after an information processing device according to the embodiment optimized the source file “ca-1” depicted in FIG. 22.

FIG. 24 is a diagram representing the number of cycles needed by the execution of the program corresponding to the source file ca-1 (referring to FIG. 23) and the number of cycles needed by the execution of the program corresponding to the optimized source file cb-1 (referring to FIG. 23).

FIG. 25 is a diagram indicating the examples of source file ca-2 including the source code for the different optimization target.

FIG. 26 represents an example of source file “cb-2” after the information processing device 100 according to the embodiment optimized the source file “ca-2” depicted in FIG. 25.

FIG. 27 is a diagram indicating the example of the source file “ca-3” including the source code for the different optimization target.

FIG. 28 illustrates an example of source file “cb-3” after the information processing device according to the embodiment optimized the source file “ca-3” depicted in FIG. 27.

### DESCRIPTION OF EMBODIMENTS

Hereinafter, embodiments will be described according to figures. But the technical range in the invention are not limited to the embodiments, are extended the subject matters disclosed in claims and its equivalents.

[Optimization of the Source Code]

The optimization processing of source code indicates the processing which revises the source code for minimizing execute time or memory consumption by streamlining of the execute file, for example. By the optimization of the source code, it is realized to decrease the execute time of the program and decrease the quantity of memory to use. For example, the optimization processing includes processing of reduction of the access number of times to an external memory, reduction of the judgment processing in the loop processing, and the reduction of the division arithmetic, for example. The compilation program generates an object code as input with the source file after the optimization.

Firstly, an example of the source code according to the embodiment will be described.

[Source Code]

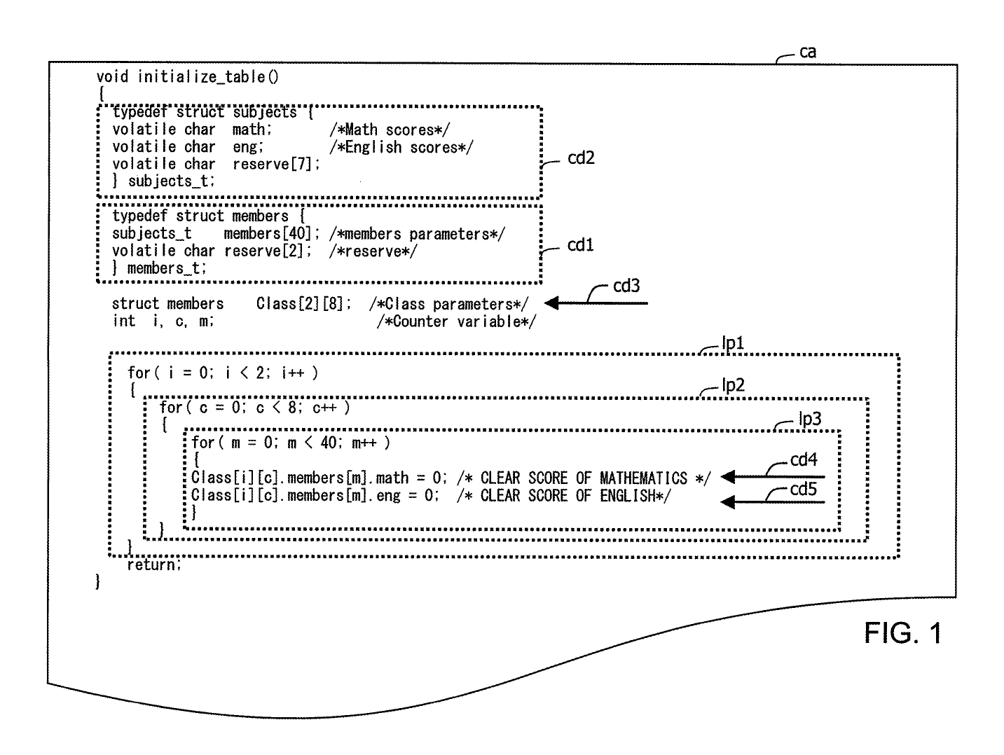

FIG. 1 is a diagram indicating an example of the source code described in the source file “ca” targeted for the optimization. The source code depicted in FIG. 1 includes loop processing and includes processing to access the member that a structure has in the loop processing.

The code “cd1” depicted in FIG. 1 is a code defining multidimensional structure “members”. The multidimensional structure “members” has the structure array (members [40]) having 40 pieces of structure bodies of the structure type “subject” and a reservation domain (reserve [2]) as the member. The multidimensional structure “members” is a structure bodies having the information about the score of each subject for 40 students.

Each of the structure “members” in the structure array (members [40]) is the structure of the subject type. In the code “cd2”, the structure of the subject type has variable “math” of the char type and variable “eng” of the char type and the reservation domain “reserve [7]” as the member. The variable “math” is a variable to store, for example, a score of the mathematics, and the variable “eng” is a variable to store an English score, for example. In this way, the structure array (members [40]) has, for example, the score information of the mathematics and the English for 40 students.

In addition, the code “cd3” depicted in FIG. 1 is a code directing to secure the domain for two sets in eight multidimensional structure “members” on the memory. The variable “Class [2] [8]” indicates the domain for two sets of eight multidimensional structure “members” which is secured on the memory.

In addition, the source code depicted in FIG. 1 has three loop processing “Ip1”-“Ip3” as the processing. First loop processing “Ip1” is a loop processing to repeat the processing in the curly bracket (“{ }”) until counter variable “i” which is incremented by every loop reaches value “1” from value “0”. In other words, the first loop processing “Ip1” repeats the processing in the curly bracket (“{ }”) twice.

The second loop processing “Ip2” is the loop processing which repeats the processing in the curly bracket (“{ }”) eight times until the counter variable “c” which is incremented reaches the value “7” from the value “0”. However the second loop processing “Ip2” is included in the first loop processing “Ip1”. Therefore, for the run time of the program, the CPU carries out the second loop processing “Ip2” in 16 (=2*8) times in total.

The third loop processing “Ip3” is loop processing to repeat 40 times of the processing in the curly bracket (“{ }”) until the counter variable “m” which is incremented by every loop reaches the value “40” from the value “0”. However, the third loop processing “Ip3” is included in the first and the second loop processing “Ip1”, “Ip2”. Therefore, for the run time of the program, the CPU carries out the third loop processing “Ip3” in “640 (=16*40)” times in total.

In addition, the third loop processing “Ip3” includes code “cd4”, “cd5” which set the value “0” in member “math” and member “eng” of the variable “Class [i] [c]. members [m]”. Especially, the “Class [i] [c]. members [m]. math=0;” “cd4” indicates processing to set the value “0” to member “math” of the structure “members” of the m number among the structure array [40] that the structure array “members” of i-th set, c-th unit has. Similarly, the code “cd5” indicates processing to set the value “0” to member “eng” of the structure “members” of the m number among the structure array [40] that the structure array “members” of i-th set, c-th unit has.

[Multidimensional Structure]

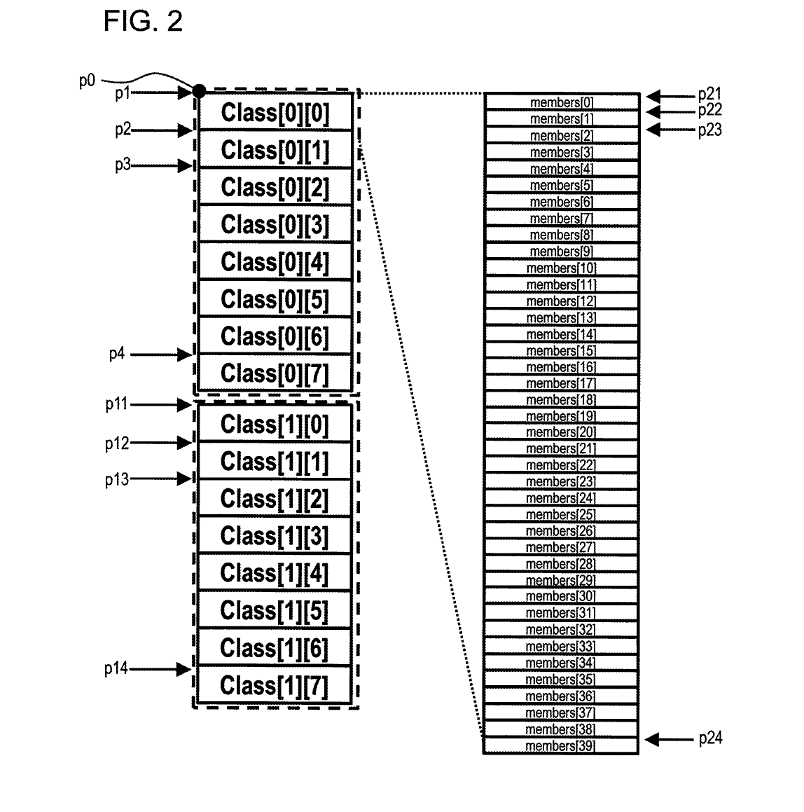

FIG. 2 is a diagram indicating the constitution of variable “Class [2] [8]” depicted in the source code of FIG. 1. The variable “Class [2] [8]” indicates eight multidimensional structure “members” for two sets as mentioned above in FIG. 1. Therefore, FIG. 2 represents the structure “Class [0] [0]-Class [0] [7]” indicating the first set eight multidimensional structure “members” and the structure “Class [1] [0]-Class [1] [7]” indicating the second set eight structure “members”.

In addition, in FIG. 2, as mentioned above in FIG. 1, each of the structure “Class [0] [0]-Class [1] [7]” has a member (structure array [40]). The member (structure array [40]) has forty structure “members” of the subject type.

An arrow “p0” depicted in FIG. 2 indicates top address of the variable “Class [2] [8]”. In addition, the arrow “p1” indicates an address of the structure “Class [0] [0]”, and is similar to the address that the arrow “p0” indicates. In addition, the arrow “p2” indicates an address of structure “Class [0] [1]”. Similarly, the arrow “p3” indicates an address of the structure “Class [0] [2]”, and the arrow “p4” indicates an address of the structure “Class [0] [7]”.

In addition, the arrow “p11” depicted in FIG. 2 indicates an address of the structure “Class [1] [0]”, and the arrow “p12” indicates an address of the structure “Class [1] [1]”. Similarly, the arrow “p13” indicates an address of the structure “Class [1] [2]”, and the arrow “p14” indicates an address of the structure “Class [1] [7]”.

An arrow “p21” indicates an address of the first structure “members [0]” among the structure array “members [40]” that the structure “Class [0] [0]” has and indicates the address similar to the arrows “p0” and “p1”. An arrow “p22” indicates an address of the second structure “members [1]” among the structure array “members [40]” that the structure “Class [0] [0]” has.

Similarly, an arrow “p23” indicates an address of the third structure “members [2]” among the structure array “members [40]” that the structure “Class [0] [0]” has, and an arrow “p24” indicates an address of the 40th structure “members [39]”.

The processing to set the value “0” in the member “math” of the variable “Class [i] [c]. members [m]” indicated in the code “cd4” indicates the processing to set the value “0” to member “math” of each structure “members” that the address “p21”-“p24” depicted FIG. 2 points to.

The processing depicted in the code “cd4” includes the calculation process of the address of variable “Class [i] [c]. members [m]. math”. The calculation process includes a calculation process of the address “p1”-“p14” of the variable “Class [i] [c]”, a calculation process of a differences from the address “p1”-“p14” to the address “p21”-“p24” of member “math” of members [m] and a process to add the difference address to the address “p1”-“p14”.

In addition, the calculation process of the address “p1”-“p14” includes an acquisition process of address “p0” of the variable “Class [0] [0]”, a calculation process of the differences from the address “p0” to the address “p1”-“p14” of the variable “Class [i] [c]” and a process to add the difference address to the address “p0”. For example, the CPU (Central Processing Unit) acquires an address of the variable “Class [0] [0]” through a memory management unit, etc.

In this way, when accessing a member (in the example of FIG. 1, “math”, “eng”) included in the structure, the calculating process of the address of the structure occurs. In other words, when the CPU execute a program corresponding to the source file “ca” depicted in FIG. 1, the CPU performs a calculation process of address “p1”-“p14” for every execution of the process of the code “cd4”. The processing depicted in the code “cd15” in FIG. 1 is similar. In addition, not illustrated in FIG. 1, but it is similar when accessing the member that the array has.

In addition, the CPU carries out the third loop processing “Ip3” total “640 (=2*8*40) times” when executing the program as mentioned above in FIG. 1. Therefore, a large number of address calculation processing occurs, when carrying out the access process of the member that the structure or structure array has in loop processing that the loop number of times is a large. Accordingly, the number of cycles demanded the execution of the program increases, thereby the performance (execute time) of the program may not satisfy an appointed value.

### SUMMARY OF EMBODIMENT

Accordingly, the information processing device (optimization device of the program) according to the embodiment detects a structure or an array having a member targeted for access in loop processing from a source code. In addition, the information processing device inserts the first code declaring a pointer variable and the second code setting an address of the structure or the array in a pointer variable, before the loop processing of the source code. In addition, the information processing device replaces a code accessing the member in the loop processing with the third code accessing a member based on the pointer variable.

In addition, it may be different from the description order of the code in the source code and the execution order of the code at the time of the execution of the program corresponding to the source code. Specifically, on the source code, it may be carried out before a predetermined code for the run time of the program even if it is a code described after the predetermined code. The insertion of the second code before loop processing indicates that the second code is carried out before the execution of the loop processing.

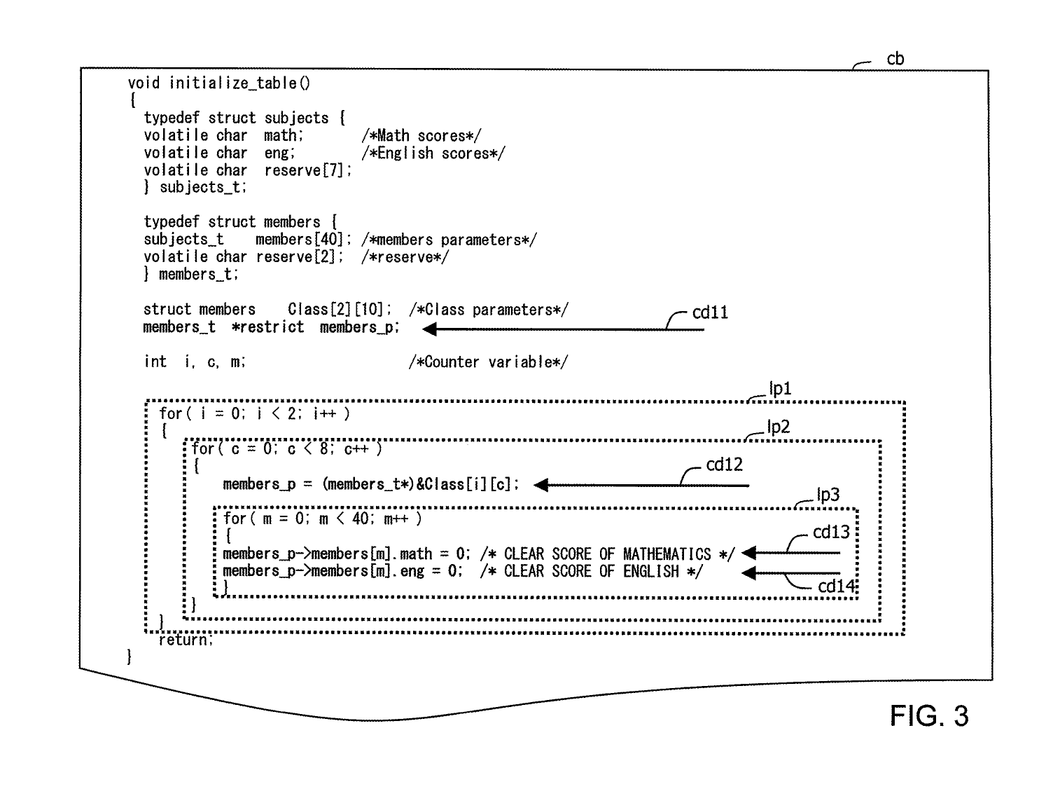

FIG. 3 is a diagram illustrates an example of the source code after the optimization that the information processing device according to the embodiment optimized the source code depicted in FIG. 1.

According to the example of FIG. 1, the information processing device detects the structure “Class [i] [c]” as the structure or the array including a member “math, eng” targeted for access in the loop processing “Ip3” from the source code depicted in FIG. 1.

And the information processing device inserts the code “cd11” declaring pointer variable “members_p” and the code “cd12” which sets the address “p1”-“p14” (referring to FIG. 2) of the structure “Class [i] [c]” to the pointer variable before the loop processing “Ip3”. In addition, the information processing device replaces the code “cd4”, “cd5” accessing the member in the loop processing “Ip3” with the code “cd13”, “cd14” accessing the member based on the pointer variable.

The code “cd11” depicted in FIG. 3 indicates a code declaring the pointer variable “members_p”. The pointer variable indicates a variable to maintain an address. In addition, the value “restrict” in the code “cd11” indicates a value for optimization processing of compiler program and indicates to admit the optimization that supposed that alias does not exist. In the example of FIG. 3, the value “restrict” is added, but the value “restrict” does not need to be added.

The code “cd12” indicates a code setting the address “&Class [i] [c]” p1-p14 of the variable “Class [i] [c]” to the pointer variable “members_p”. Based on the pointer variable “members_p,” the code “cd13”, “cd14” indicate processing of accessing each member of the variable “Class [i] [c]. members [m]”, and setting of value “0”.

The code “cd13”, “cd14” indicate a code accessing a member based on the pointer variable “members_p” having the address “p1”-“p14”. Thereby, for run time of the code “cd13”, and “cd14”, a calculation process of the address p1-p14 in the variable “Class [i] [c]” does not occur. In other words, by replacing it with the access processing based on the pointer variable, it is possible to omit the calculation process of the address of the structure (or array).

In other words, for run time of “cd13”, “cd14”, a process to acquire the address “p0” depicted in FIG. 2, a process to calculate an address for differences from the address “p0” to the address “p1”-“p14” and a process to add the address p0 and the difference address do not produce. In addition, according to the source code of FIG. 3, the second loop processing “Ip2” has the code “cd12” calculating the address “p1”-“p14” newly.

The total loop number of times “16” (=2*8) of the second loop processing “Ip2” is largely little for the total loop number of times “640” (=16*40) of the third loop processing “Ip3”. Therefore, it is possible to largely reduce the number of times of the calculation processing of address “p1”-“p14” by moving the calculation processing of the address “p1”-“p14” outside the third loop processing “Ip3”.

In this way, the information processing device according to the embodiment restrains the calculation process of the address of the structure, by moving the calculation process of the address of the structure, including a member targeted for access in the loop processing, outside the loop processing. Thereby it is possible that the information processing device realizes the reduction of the number for a cycle of the value “address calculation processing X total loop number of times”.

In this way, throughput for the program run time largely decreases by restraining the number of times of calculating of the address in the loop processing to perform repeatedly, thereby it is possible to largely reduce the number of for a cycles needed by the execution of the program. Speedup of the execute time of the program becomes in this way feasible.

In addition, it is possible that the information processing device raise the restraint degree of calculating of the address so that the nest of the loop is deep and the loop number of times of the loop processing including the access processing is a large. In addition, it is possible that the information processing device raise the restraint degree of calculating of the address so that there is much number of codes (code “cd4”, “cd5” of FIG. 1) of the access processing in the loop processing. In addition, it is possible that the information processing device raise the restraint degree of calculating of the address so that a hierarchy of the target structure and array which move calculating process of the address is deep.

In addition, according to the optimization processing in the embodiment, it is possible to restrain the number of address registers to use because the number of times of calculating process of the address in the access processing is restrained. Thereby, it is possible to suppress latency of the processing, since frequency of performing the saving by the memory transfer to stack pointer, by lack of the address register, is decreased.

In addition, it is possible that the information processing device according to the embodiment realizes the optimization processing of source code easily without asking an engineer of the election for the optimization processing. Thereby it is possible to reduce the cost and the man-hour that optimization processing costs. In addition, the information processing device does not complicate the source code according to optimization processing. Therefore, it is possible that the information processing device maintain the maintainability of the program without decreasing the readability of the source code.

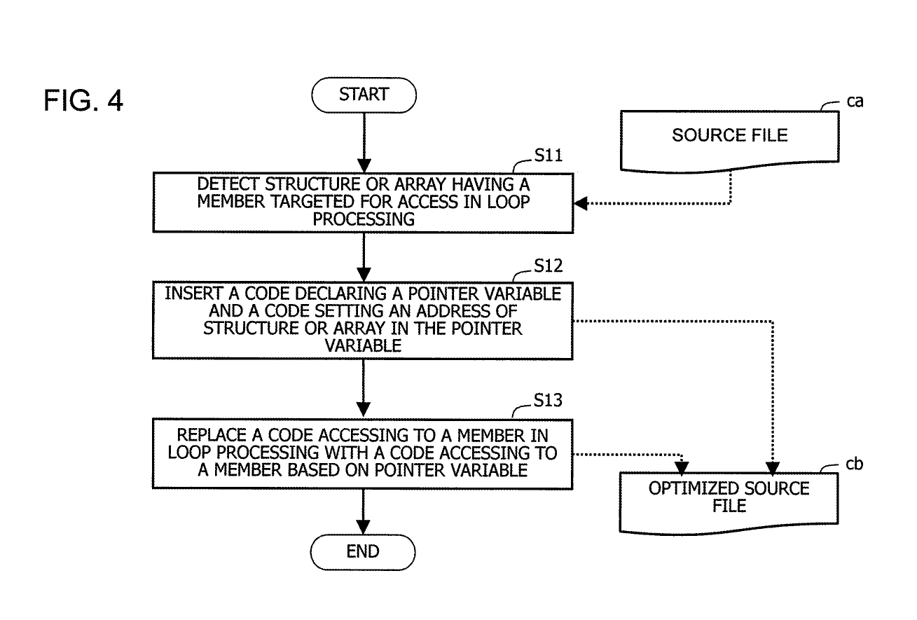

FIG. 4 is a diagram of flow chart explaining the optimization processing of source code of the information processing device according to the embodiment.

S11: The information processing device retrieves the source code from the source file “ca” and detects the structure or the array having the member targeted for access in the loop processing. According to the source code in FIG. 1, the information processing device detects the structure “Class [i] [c]. members [m]” based on the code “cd14”, “cd15” in the third loop processing.

S12: The information processing device inserts the first code declaring a pointer variable and the second code setting an address of the structure or the array in the pointer variable before the loop processing. According to the example of FIG. 3, the information processing device inserts the first code “cd11” declaring the pointer variable “members_p” and the second code “cd12” which sets an address of structure “Class [i] [c]” in the pointer variable “members_p” before the third loop processing “Ip3”.

S13: The information processing device replaces a code accessing the member in the loop processing with a code accessing the member based on the pointer variable. Thus, the information processing device generates an optimized source file “cb”.

According to the example of FIG. 3, the information processing device replaces the code “Class [i] [c]. members [m]. math=0;” cd4 depicted in the source code of FIG. 1 with the code “members_p->members [m]. math=0” cd13 based on the pointer variable “members_p”. Similarly, the information processing device replaces the code “Class [i] [c]. members [m]. eng=0;” cd5 depicted in the source code of FIG. 1 with the code “members_p->members[m]. eng=0” cd14 based on the pointer variable “members_p”.

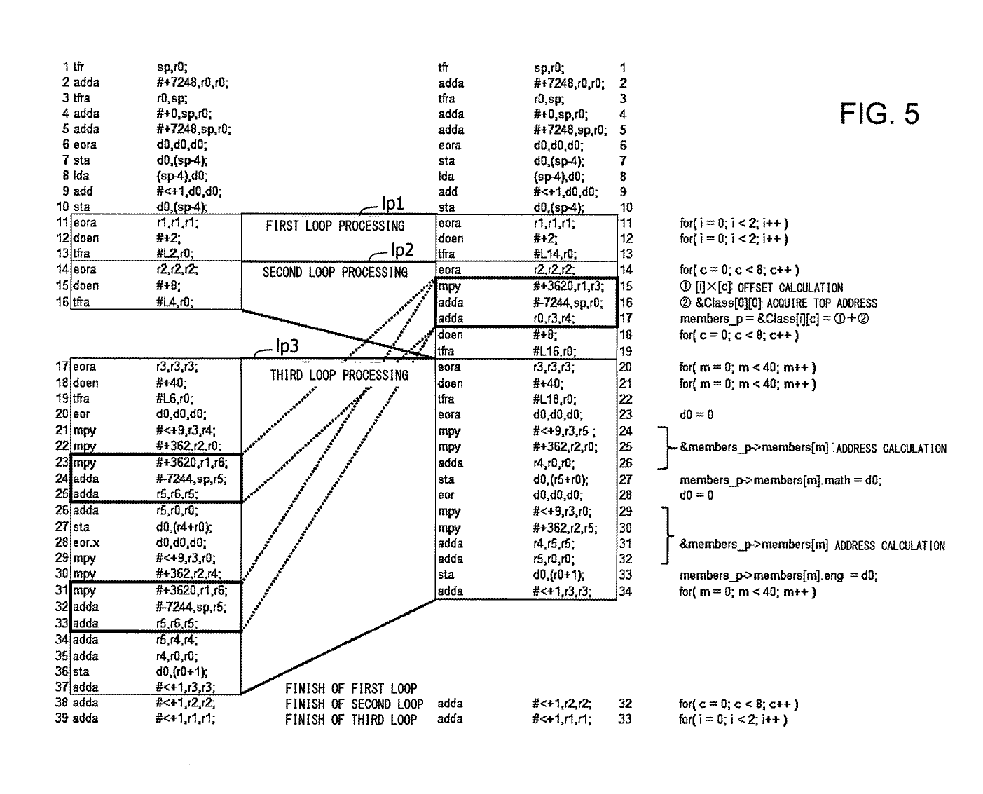

FIG. 5 is a diagram illustrating a relation of instructions of the program corresponding to the source file “ca” depicted in FIG. 1 with the instructions of the program corresponding to the source file (optimized source file) “cb” depicted in FIG. 3. The left-hand portion in FIG. 5 indicates the instructions of the program corresponding to the source file “ca” of FIG. 1, and the right hand portion of FIG. 5 indicates the instructions of the program corresponding to the source file “cb” after optimization in FIG. 3.

Firstly the instructions of the program corresponding to source file “ca” of FIG. 1 will be described. The instructions on 17-37 lines in the left-hand portion of FIG. 5 indicate the third loop processing “Ip3”. In addition, the instructions on 14-38 lines indicate the second loop processing “Ip2”, and the instructions on 11-39 lines indicate the first loop processing “Ip1”.

The instructions on 20-27 lines among the instructions on 17-37 lines corresponding to the third loop processing Ip3 indicate the processing (cd4) which sets the value “0” at the variable “Class [i] [c]. members [m]. math”. In addition, the instructions on 28-36 lines indicate the processing (cd5) that sets the value “0” in the variable “Class [i] [c]. members [m]. eng”.

In addition, the instructions on 23-25 lines among the instruction on 20-27 lines corresponding to the code “cd4” indicate the calculation process of the address “p1-p14” of the structure “Class [i] [c]”. Especially, the instruction on 23 line indicate the acquisition processing of the address “p0” of the structure “Class [0] [0]” and the instruction on line 24 indicate the calculation processing of the difference address from the address “p0” to the address “p1”-“p14” of the structure “Class [i] [c]”. In addition, the instruction on 25 line indicate the addition processing with the address “p0” and the difference address.

Similarly, the instructions on 31-33 lines among the instructions on 28-36 lines corresponding to the code “cd5” indicate the calculation process of the address “p1”-“p14” of the structure “Class [i] [c]”. The details of the processing of the instructions on 31-33 lines are similar to the processing of the instructions on 23-25 lines.

Then, the instructions of the program corresponding to the source file “cb” (referring to FIG. 3) after the optimization in FIG. 3 will be explained. The instructions on 20-34 lines of the right hand portion in FIG. 5 indicate the third loop processing “Ip3”. In addition, the instructions on 14-32 lines indicate the second loop processing “Ip2”, and the instructions on 11-33 lines indicate the first loop processing “Ip1”.

According to the example of FIG. 3, the second loop processing “Ip2” includes the processing (cd12) setting an address of the variable “Class [i] [c]” in the pointer variable “members_p”. The instructions on 15-17 lines among the instructions on 14-32 lines corresponding to the second loop processing “Ip2” indicate the processing of code “cd12”. In addition, each of the processing on 15-17 lines is similar to the processing on 23-25 lines and on 31-33 lines depicted in left-hand portion of FIG. 5.

In addition, the instruction on 23-27 lines among the instructions on 20-34 lines corresponding to the third loop processing “Ip3” indicate the processing (code cd13) which sets the value “0” in the variable “members_p->members[m]. math”. In addition, the instructions on 28-33 lines indicate the processing (code cd14) to set the value “0” in the variable “members_p->members[m]. eng”. According to the left-hand portion of FIG. 5, the third loop processing “Ip3” does not have the calculation process (lines 15-17) of the address of the variable “Class [i] [c]”. In this way, it is possible to reduce a processing cycle because it is possible to omit three instructions on 15-17 lines at every execution of the code “cd13” and “cd14”.

(Cycle Number)

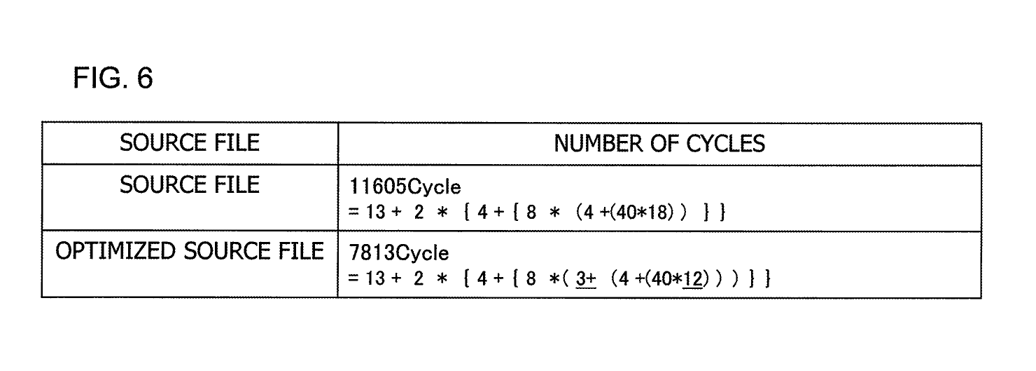

FIG. 6 is a diagram illustrating the number of the cycles needed for the execution of the program corresponding to the source file “ca” of FIG. 1 and the number of the cycles needed for the execution of the program corresponding to the source file “cb” after the optimization of FIG. 3.

Firstly the number of the cycles needed for the execution of the program corresponding to the source file “ca” of FIG. 1 will be explained. For example, according to the program corresponding to source file “ca” of FIG. 1, the number of the cycles needed for execution of the third loop processing “Ip3” is 18 cycles. In addition, the loop number of times of the first loop processing “Ip1” is twice, and the loop number of times of the second loop processing “Ip2” is eight times, and the loop number of times of the third loop processing “Ip3” is 40 times.

Therefore, the number of the cycles needed the execution of the program corresponding to the source file “ca” of FIG. 1 is the value “11605 Cycle” which is calculated according to an expression “13+2*{4+{8*(4+(40*18))}}”, for example.

On the other hand, according to the program corresponding to source file “cb” of FIG. 3, the processing of three instructions decreases in every codes “cd13” and “cd14”. Therefore, at every third loop processing “Ip3”, the processing of six instructions is decreased. Therefore, the number of times of the cycle needed for the execution of the third loop processing “Ip3” is twenty cycles, for example. On the other hand, at every second loop processing “Ip2”, the processing of three instructions is increased.

Therefore, for example, the number of cycles needed for the execution of the program corresponding to the optimized source file “ca” is the value “7813 Cycle” which is calculated according to the expression “13+2*{4+{8*(3+(4+(40*12)))}}”. In this way, by the optimization processing of the source code, the number of the cycles becomes “0.673” (≈7813/11605), and the number of cycles decreases to approximately 68%.

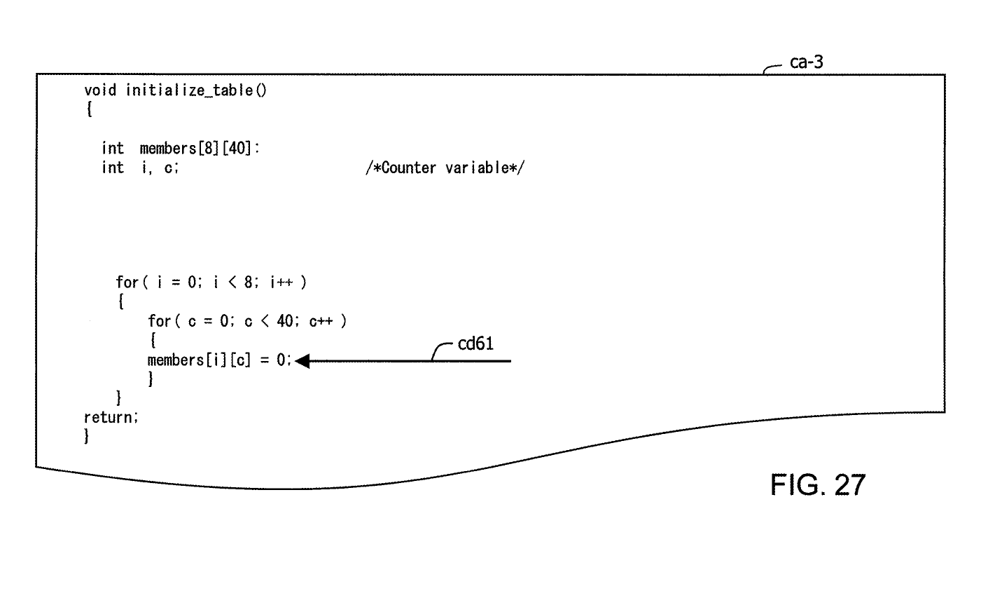

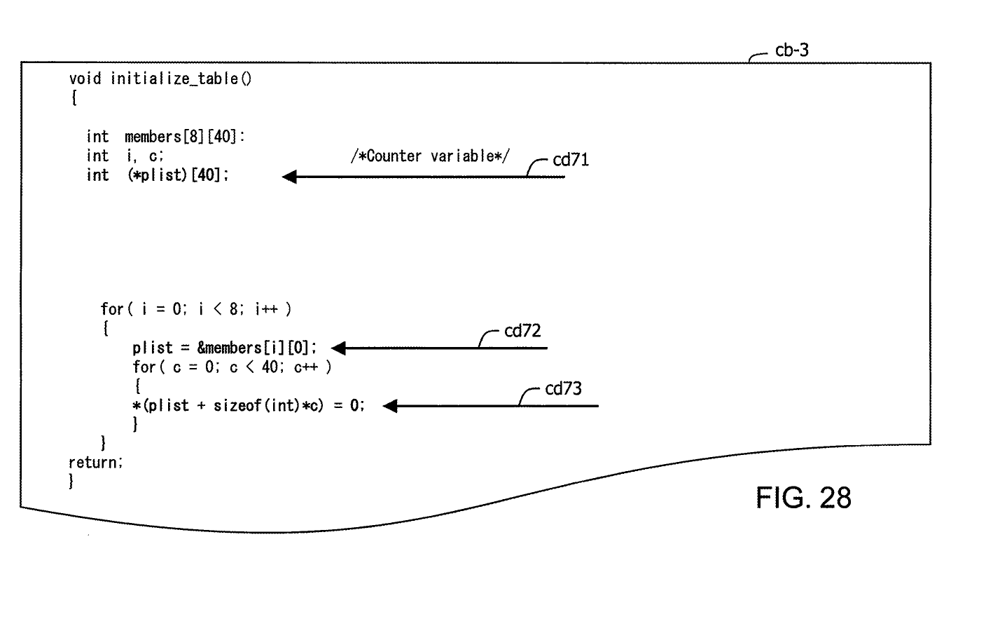

In addition, the example of FIG. 1 and FIG. 3 indicates the example of the structure having a member, but the optimization processing according to the embodiment is effective about the array including the member. An example applying to the array will be described later according to FIG. 27, FIG. 28.

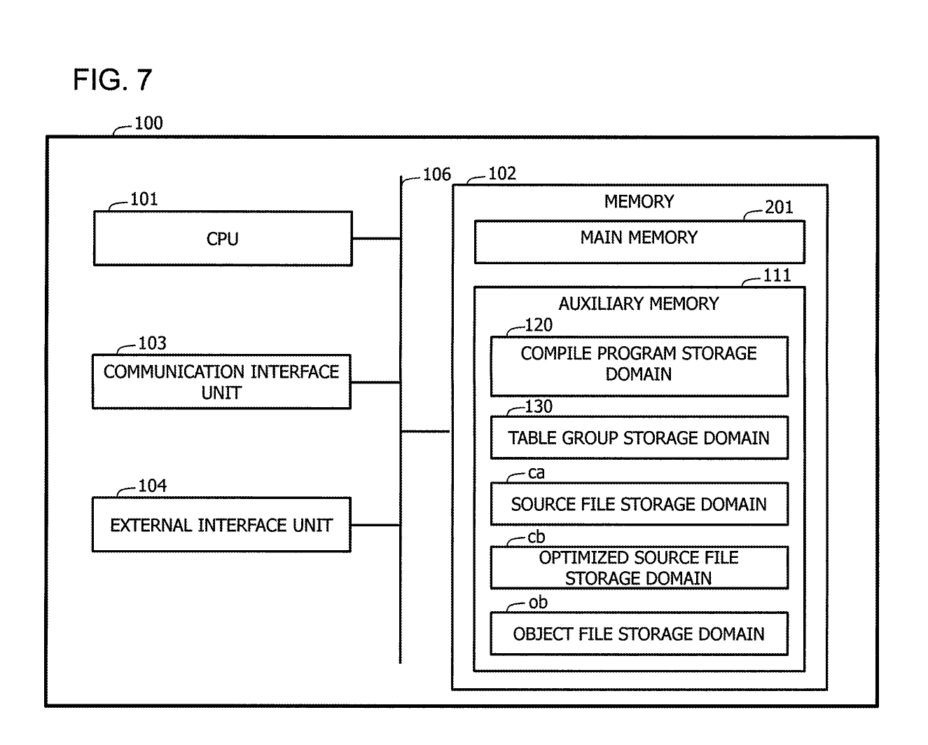

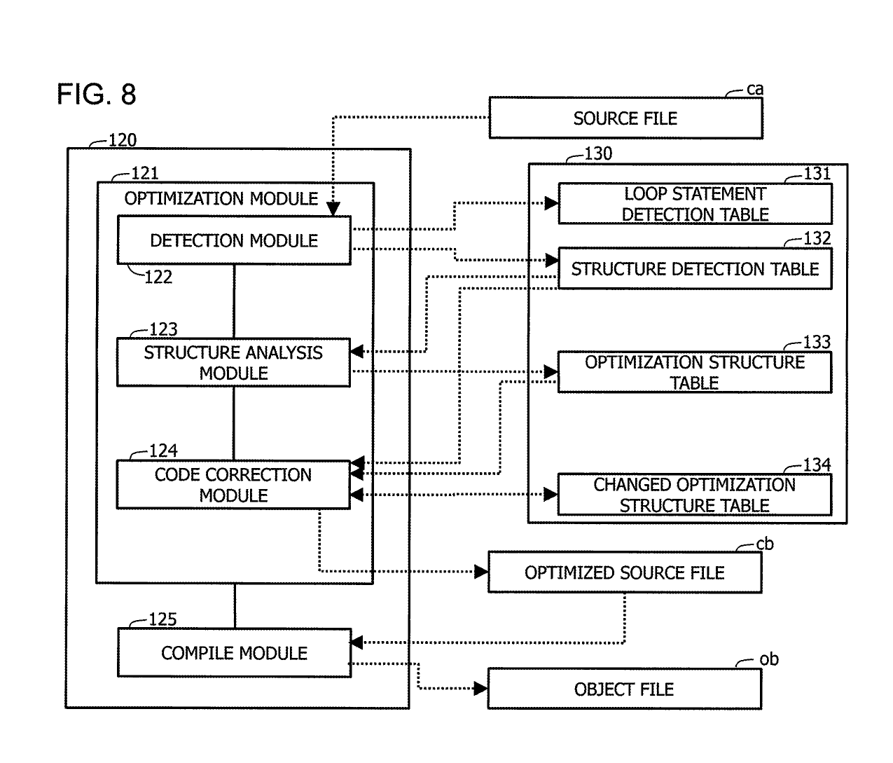

Then, according to FIG. 7, FIG. 8, the hardware and software constitution of the information processing device according to the embodiment will be described.

[Hardware Constitution of Information Processing Device 100]

FIG. 7 is a diagram of hardware constitution of the information processing device (optimization device of the program) 100 according to the embodiment. The information processing device 100 includes a CPU (Central Processing Unit) 101, a memory 102 having a main memory 201 and an auxiliary memory 111, etc., a communication interface unit 103, an external interface unit 104, for example. The all parts are connected through a bus 106 mutually.

The CPU 101 is connected to the memory 102 etc. through the bus 106 and controls the whole information processing device 100. The communication interface unit 103 is connected to other devices (not illustrated in FIG. 7) through the internet and performs an access for the network. The main memory 201 including a RAM (Random Access Memory) memorizes the data of which the CPU 101 processes. In addition, the external interface unit 104 connects with a storage device SD.

The auxiliary memory 111 includes a domain (not illustrated in FIG. 7) storing the program of the operation system of which the CPU 101 carries out. In addition, the auxiliary memory 111 includes compile program storage domain 120, table group storage domain 130. In addition, the auxiliary memory 111 includes source file storage domain “ca”, optimized source file storage domain “cb”, object file storage domain “ob”. The auxiliary memory 111 includes an HDD (Hard disk drive), or nonvolatile semiconductor memory, etc.

The compile program (below called as the compile program 120) in the compile program storage domain 120 realizes processing of compile program (optimization program) 120 by the execution of the CPU 101. The table group in the table group storage domain 130 (below called as table group 130 as follows) is the table that the compile program 120 produces. Each table included in the table group 130 will be mentioned later according to FIG. 8.

The source file (below called as the source file “ca”) in the source file storage domain “ca” is a file becoming the input of compile program 120 and indicates the source file “ca” targeted for the optimization processing. The optimized source file in the optimized source file storage domain “cb” (called as optimized source file “cb”) is a file which is generated by optimized by the compile program 120, and indicates a file targeted for a compile.

The object file (below called as object file “ob”) in the object file storage domain “ob” is a file that the compile program 120 compiles the optimized source file “cb” as input and generates.

[Software Block of Information Processing Device 100]

FIG. 8 is a diagram illustrating constitution of the software block of the compile program 120 depicted in FIG. 7. The compile program 120 has an optimization module 121 and a compile module 125. The optimization module 121 has a detection module 122, a structure analysis module 123, and a code correction module 124, for example.

The optimization module 121 generates the optimized source file “cb” as input in the source file “ca”. In addition, the optimization module 121 generates the table group 130 (referring to FIG. 7). The compile module 125 performs compile processing of the optimized source file “cb” and generates the object file “ob”.

In addition, the table group 130 has a loop statement detection table 131, a structure detection table 132, an optimization structure table 133, and a changed optimization structure table 134.

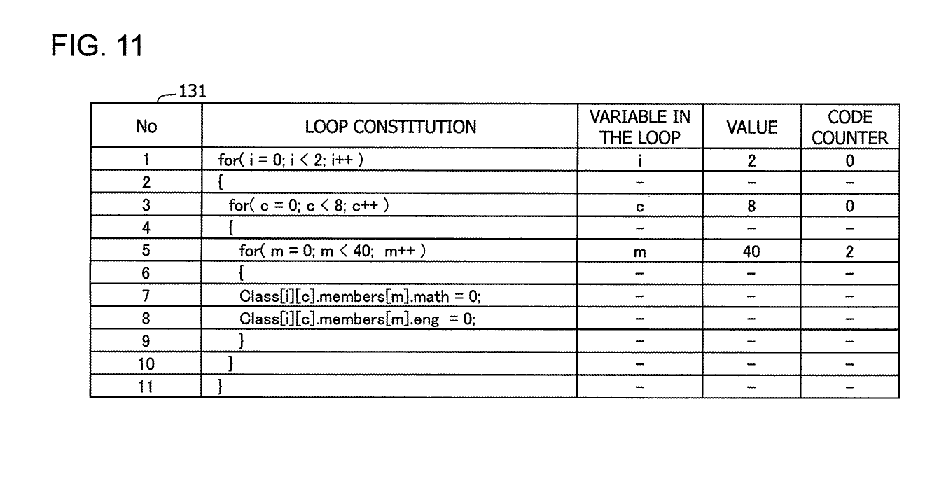

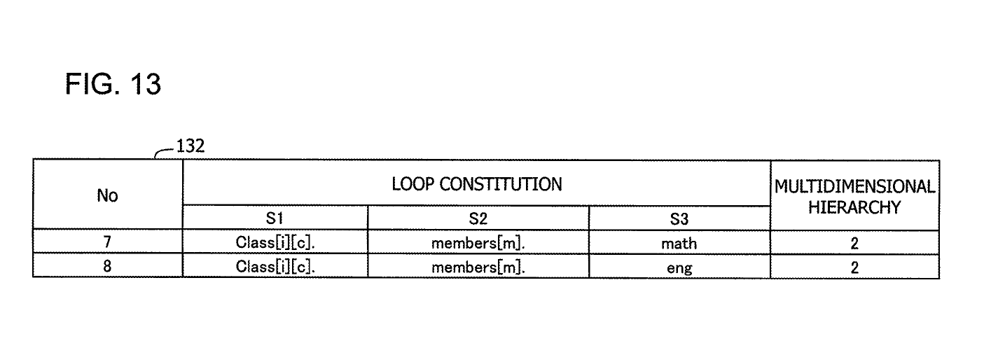

The loop statement detection table 131 is a table having information of the loop processing in the source code described in the source file “ca”. The details of loop statement detection table 131 will be mentioned later according to FIG. 11. The structure detection table 132 is a table including information about the constitution of the structure having the member targeted for access in the loop processing. The details of the structure detection table 132 will be mentioned later according to FIG. 13.

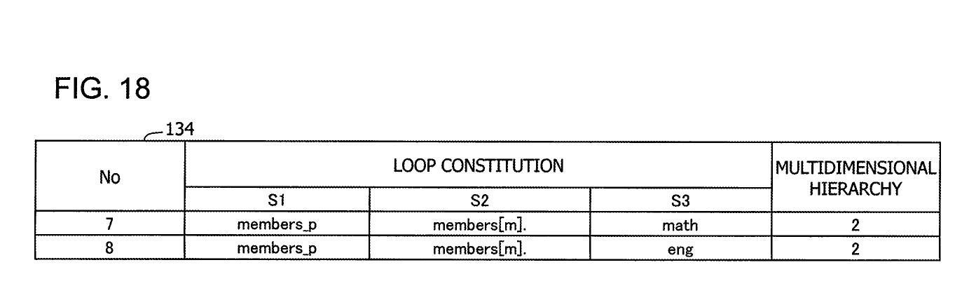

The optimization structure table 133 is a table having information, which indicate the presence or absence of the value change of the address of the structure memorized to the structure detection table 132 for every loop processing, for every hierarchy of the structure. The details of the optimization structure table 133 will be mentioned later according to FIG. 15. The changed optimization structure table 134 is a table having the information about the pointer variable of the structure stored by the structure detection table 132. The details of changed optimization structure table 134 will be mentioned later according to FIG. 18.

The detection module 122 detects a code corresponding to the loop processing among the codes described in the source file “ca” as input in the source file “ca” and memorizes it to the loop statement detection table 131. In addition, the detection module 122 refers with the loop statement detection table 131, analyzes the constitution of the structure, and generates the structure detection table 132 having the information about the constitution of the structure. The structure analysis module 123 refers to the structure detection table 132, analyzes access processing in the loop processing of the structure that is detected, and generates the optimization structure table 133.

The code correction module 124 generate the name of the pointer variable based on the type of the structure to set in the pointer variable with reference to the optimization structure table 133 and memorize it to the changed optimization structure table 134. In addition, the code correction module 124 copies the source file “ca”, generates the optimized source file “cb” and revises a source code in the optimized source file “cb” with reference to the changed optimization structure table 134.

[Flow of Processing of Compile Program 120]

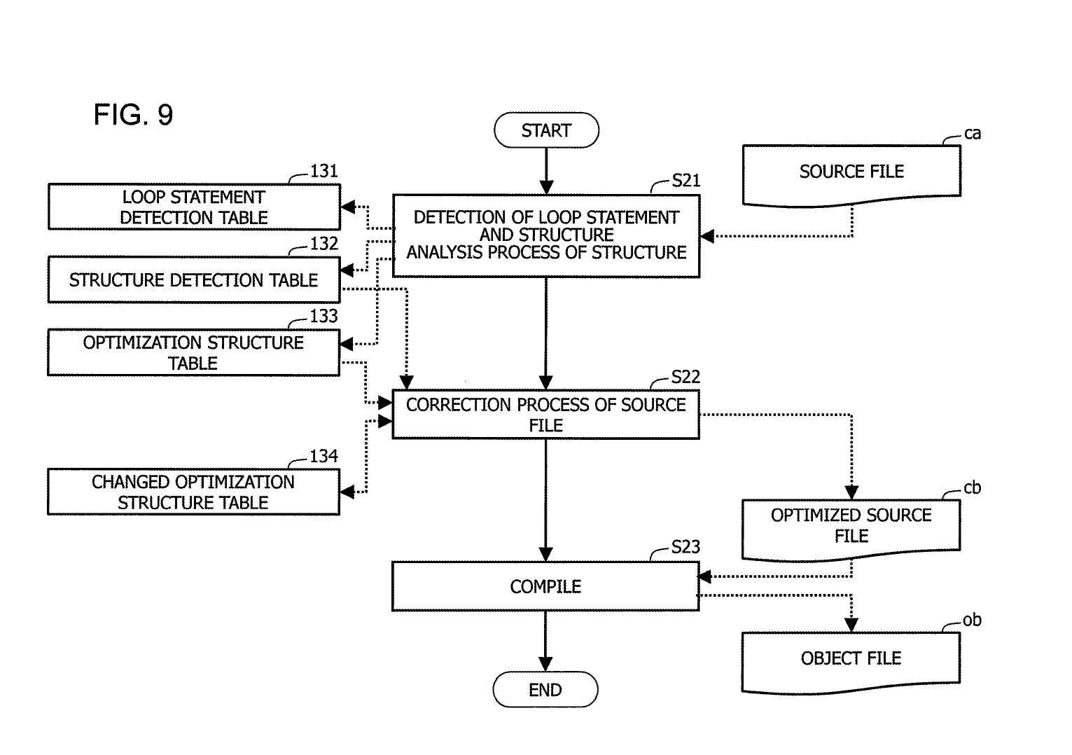

Then, according to a flow chart of FIG. 9, the details of the processing of compile program 120 that is explained in FIG. 8 will be described.

FIG. 9 is a diagram of flow chart explaining the details of the processing of compile program 120 that is explained in FIG. 8.

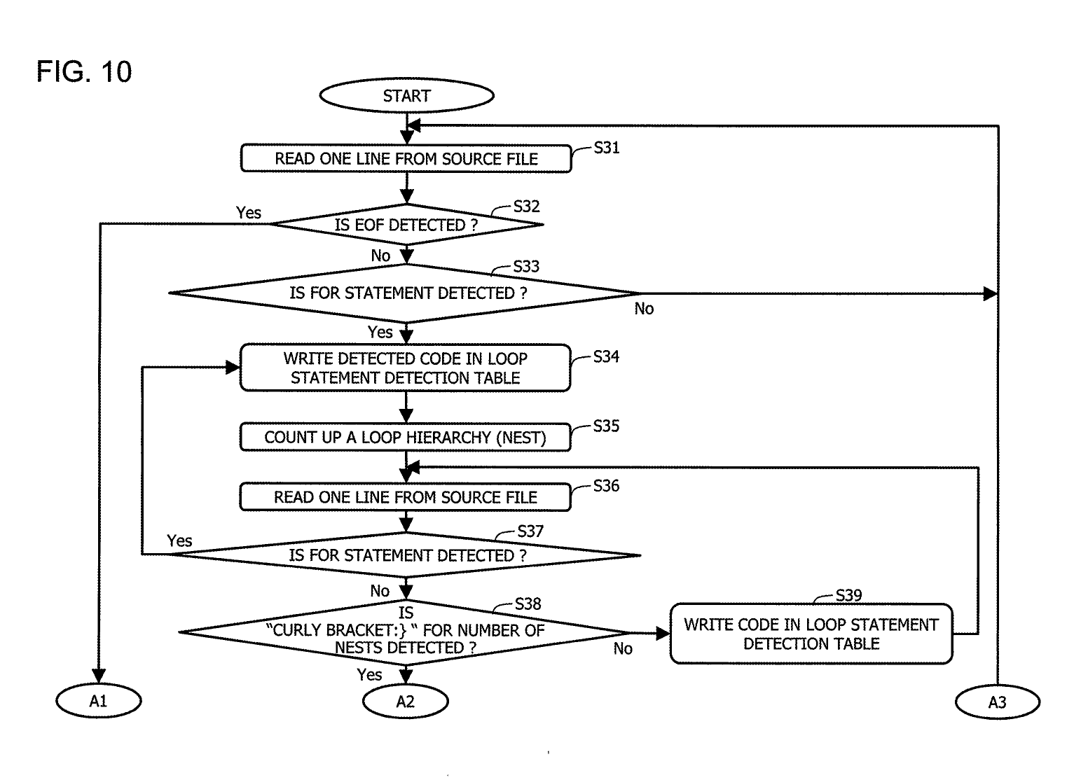

S21: The detection module 122 carries out the processing of detection of the loop statement and the structure as input in the source file “ca”. In addition, the structure analysis module 123 performs analysis processing of constitution of the structure with reference to the structure detection table 132. The details of the processing in the process S21 will be mentioned later according to FIG. 10-FIG. 15.

Especially, as mentioned above in FIG. 8, the detection module 122 detects a code corresponding to the loop processing and memorizes it to the loop statement detection table 131. In addition, when the access processing to the member of the structure is included in the code corresponding to the loop processing, the detection module 122 memorizes it to the structure detection table 132. In addition, the structure analysis module 123 performs analysis processing of constitution of the structure with reference to the structure detection table 132 and memorizes it to the optimization structure table 133.

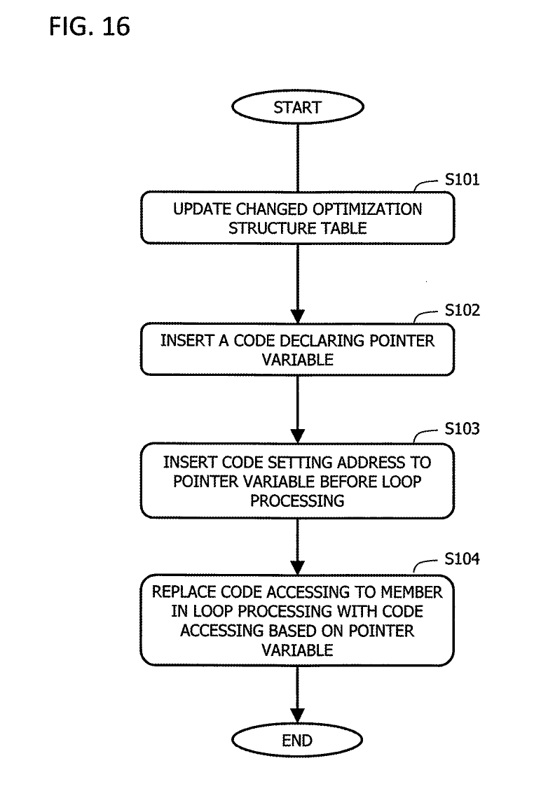

S22: The code correction module 124, based on the analysis result of the structure, decides the type of the pointer variable and carries out the correction processing of the code for the optimized source file “cb”. The details of the processing in the process S22 will be mentioned later according to FIG. 16.

Especially, the code correction module 124 sets an address of the structure or the array that an address does not change at every loop processing in the pointer variable with reference to the optimization structure table 133. In other words, the code correction module 124, when the address of the structure (or array) having the member is constant outside of the loop processing, moves the set of the address of the structure concerned to outside of the loop processing. Thereby, it is possible that the code correction module 124 detects a structure (or array) that a change of the address does not occur outside of the loop processing appropriately.

In addition, the code correction module 124 decides the name of the pointer variable and memorizes the name of the pointer variable that is decided to the changed optimization structure table 134. In addition, the code correction module 124 performs the insertion and replacement processes of the code for the optimized source file “cb” based on the name of the pointer variable. The code correction module 124 moves the calculation process of the address of the detected structure (or array) outside of the loop processing according to the insertion and replacement of the code.

S23: The compile module 125 performs compile processing of the optimized source file “cb” and generates the object file “ob”. In addition, a linker module, which is not illustrated in FIG. 9, generates an execution program as input in one or more object file “ob”.

In addition, a user may select the right or wrong of the execution of the optimization processing according to the embodiment. Thereby it is possible to realize the debugging processing that the developer aims at the time of debugging and to raise the performance without reducing development efficiency, by performing the optimization processing after completion of the debugging.

(Processing of Process S21)

FIG. 10 is a diagram of first flow chart explaining the details of the processing of process S21 which is explained in FIG. 9.

S31: The detection module 122 reads one line of code from the source file “ca”.

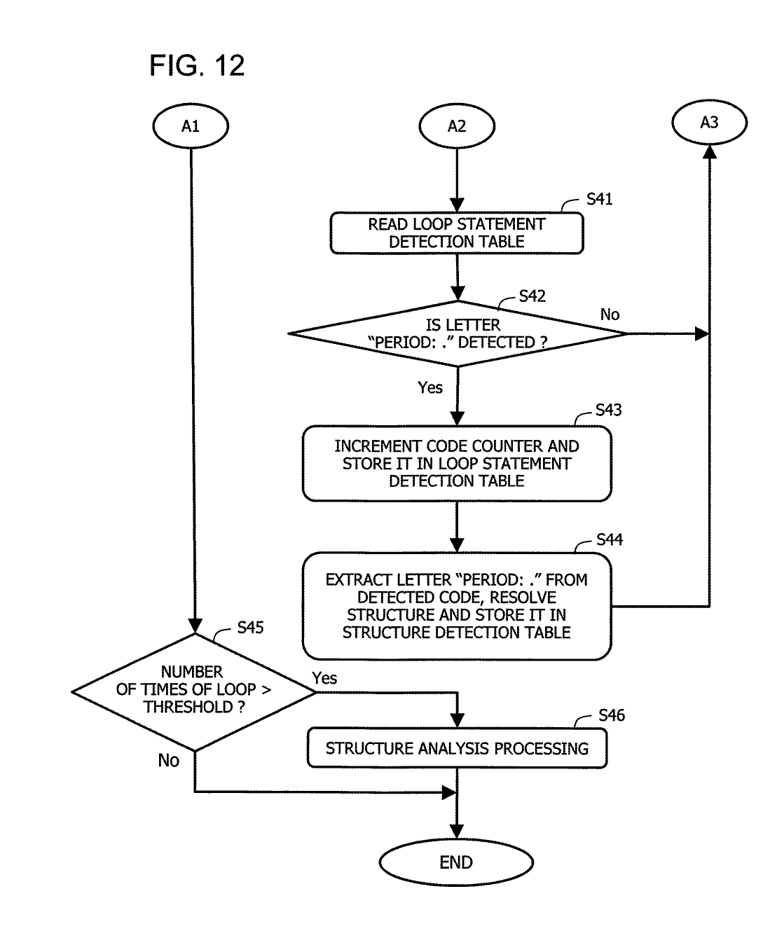

S32: The detection module 122 determines whether or not the end (End Of File:EOF) of the source file “ca” is detected. When the end of source file “ca” is detected (Yes of S32), the detection module 122 moves to the processing “A1”. The processing “A1” will be mentioned later in a flow chart of FIG. 12.

S33: When the end of source file “ca” is not detected (No of S32), the detection module 122 judges whether the code that is read includes “for statement”. When the “for statement” is not included (No of S33), the detection module 122 changes for the processing of process S31 and begins to read one line of code again from the source file “ca”.

S34: On the other hand, when the code which is read includes the “for statement” (Yes of S33), the detection module 122 writes the code which is read into the loop statement detection table 131. The loop statement detection table 131 will be mentioned later according to FIG. 11.

S35: The detection module 122 counts up the counter indicating the loop hierarchy (nest) in response to the detection of the “for statement”.

S36: The detection module 122 retrieves one line of code more from the source file “ca”.

S37: The detection module 122 judges whether the code which is read includes the “for statement”. When the code which is read includes the “for statement” (Yes of S37), the detection module 122 moves to the processing of process S34 and writes the code which is read into the loop statement detection table 131.

S38: On the other hand, when the code which is read does not include the “for statement” (No of S37), the detection module 122 judges whether the code which is read includes letter “curly bracket:}” and judges whether the letter “curly bracket:}” corresponding to the number of the loop hierarchies are detected.

S39: When the code which is read does not include the letter “curly bracket:}” (No of S38) or when the letter “curly bracket:}” corresponding to the number of the loop hierarchies are not detected although the letter “curly bracket:}” is included (No of S38), the detection module 122 writes the code which is read into the loop statement detection table 131. And the detection module 122 changes in the process S36 and begins to read one line of code more from the source file “ca”.

On the other hand, the detection module 122 changes in processing “A2” when the code which is read includes the letter “curly bracket:}” and the letter “curly bracket:}” corresponding to the number of the loop hierarchies are detected (Yes of S38). The processing “A2” will be mentioned later in a flow chart of FIG. 12.

(Loop Statement Detection Table 131)

FIG. 11 is a diagram representing an example of loop statement detection table 131. The loop statement detection table 131 includes an item “NO”, an item “loop constitution”, an item “variable in the loop”, an item “value” and an item “code counter”. The item “NO” indicates the identification information of each code.

The item “loop constitution” indicates the code corresponding to the “for statement” which is read from the source file “ca”. The code corresponding to the “for statement” indicates codes from the “for statement” to the letter “curly bracket:}”. As illustrated in FIG. 11, the loop statement detection table 131 has a code corresponding to the loop processing of a plurality of hierarchies when the “for statement” is the loop processing of the plurality of hierarchies.

The item “variable in the loop” indicates the name of the counter variable of the “for statement”, and the item “value” has maximum in the continuation condition expression (for example, “I<2”) of the counter variable. Therefore, the counter variable of the first loop processing “Ip1” is a variable “i”, and a value is “2”. Similarly, the counter variable of the second loop processing “Ip2” is a variable “c”, and a value is “8”, and the counter variable of the third loop processing “Ip3” is a variable “m”, and a value is “40”.

In addition, the item “code counter” indicates the number of the codes that performs the access processing to the member of the structure in a processing of the “for statement”. According to the example of FIG. 11, the third loop processing “Ip3” has two codes which perform the access processing to the member of the structure. Therefore, the code counter corresponding to the third loop processing “Ip3” becomes value “2”.

FIG. 12 is a diagram of second flow chart explaining the processing of process S21 which is explained in FIG. 9.

S41: The detection module 122 reads the loop statement detection table 131 (FIG. 11) as processing A2 of the flow chart in FIG. 10.

S42: The detection module 122 judges whether the letter “period: .” is detected from the item “loop constitution” in the loop statement table 131.

S43: When letter “period: .” is detected (Yes of S42), it indicates that a code, which performs the access processing to the member of the structure, exists within the loop processing. Therefore, the detection module 122 increments the code counter and memorizes it to the loop statement detection table 131. Especially, according to the loop statement detection table 131 in FIG. 11, the detection module 122 sets the code counter to value “2” in order to detect the code “Class [i] [c]. members [m]. math=0;” and the code “Class [i] [c]. members [m]. eng=0;” including the letter “period: .”.

On the other hand, when the letter “period: .” is not detected (No of S42), it indicates that a code, which performs the access processing to the member of the structure, does not exist within the loop processing. Therefore, the detection module 122 moves in the processing A3 of the flow chart in FIG. 10 and reads one line of code from the source file “ca”. Therefore, the detection module 122 detects different loop processing and memorizes it in the loop statement detection table 131.

S44: Detection module 122 resolves the structure by extracting the letter “period: .” from the code which is detected. And the detection module 122 memorizes the constitution of the structure which is resolved into the structure detection table 132. The details of structure detection table 132 will be mentioned later according to FIG. 13.

According to the loop statement detection table 131 in FIG. 11, the detection module 122 resolves into the structure “Class [i] [c]”, the structure “members [m]” and the member “math” based on the code “Class [i] [c]. members [m]. math=0;” and memorizes it to the structure detection table 132. Similarly, the detection module 122 resolves into the structure “Class [i] [c]”, the structure “members [m]” and the member “eng” based on code “Class [i] [c]. members [m]. eng=0;” and memorizes it to the structure detection table 132.

After resolving the structure, the detection module 122 moves in processing A3 of the flow chart in FIG. 10 and reads one line of code from the source file “ca” and detects different loop processing.

S45: In addition, the detection module 122, as processing A1 of the flow chart in FIG. 10, judges whether the total loop number of times of the loop processing, that the value of the code counter is over or equal the value “1”, exceeds the threshold. In other words, the detection module 122 judges whether the total loop number of times of the third loop processing “Ip3” exceeds the threshold when detecting the end of source file “ca” (Yes of S32 in FIG. 10). The threshold is a value to be set according to inspection beforehand. In this embodiment, for example, the threshold is value “10”.

When the loop is the loop of multi hierarchies, in other words, when target loop processing “Ip3” is included in different loop processing “Ip2”, the total loop number of times indicates the product with the first loop number of times of the loop processing “Ip3” and the second loop number of times of different loop processing “Ip2”. For example, according to the example in FIG. 1, the total loop number of times of the third loop processing Ip3 is value “640 (=2*8*40)”.

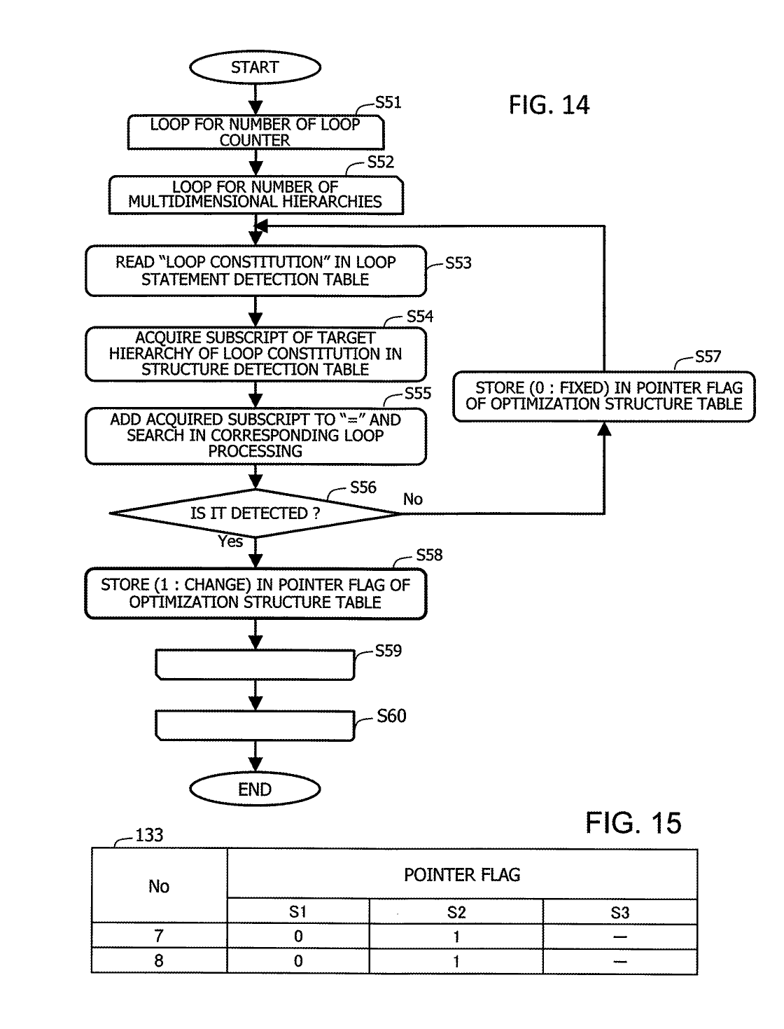

S46: When the total loop number of times exceeds the threshold (Yes of S45), the structure analysis module 123 performs the structure analysis processing which is mentioned later in FIG. 14. On the other hand, when the total loop number of times does not exceed the threshold (No of S45), the structure analysis module 123 does not perform the structure analysis processing. In other words, the structure analysis module 123 does not subject to the optimization processing about the loop processing that the total loop number of times does not exceed the threshold.

Because there is not much number of times of the access processing when the total loop number of times does not exceed the threshold (No of S45) even if the loop processing includes the access processing for the member of the structure, there is not much number of times of the calculation processing of the address, too. Therefore, a reduction rate of the number of the cycles may not grow big even if the calculation processing of address of the structure moves outside the loop processing.

Therefore, the detection module 122 according to the embodiment detects a structure or array having the member that is targeted for access in the loop processing that the total loop number of times is more than a predetermined value. In other words, it is possible that the detection module 122 detects the structure or the array that reduces significantly the number of cycles by exempt of optimizing the access process included in the loop processing, of which the total loop number of times does not exceed the threshold.

(Structure Detection Table 132)

FIG. 13 is a diagram indicating an example of structure detection table 132. The structure detection table 132 has an item “NO”, an item “loop constitution”, and an item “multidimensional hierarchy”, for example. The item “NO” was explained by the loop statement detection table 131 in FIG. 11.

The item “loop constitution” in the structure detection table 132 depicted in FIG. 13 has items “S1”, “S2” and “S3” indicating the hierarchy of the structure more.

As mentioned above in the process S44 of the flow chart in FIG. 12, the structure detection table 132 has a value “Class [i] [c]” (=S1), a value “members [m]” (=S2), a value “math” (=S3), based on the code “Class [i] [c]. members [m]. math=0;”. Similarly, the structure detection table 132 has a value “Class [i] [c]” (=S1), a value “members [m]” (=S2), a value “eng” (=S3) based on the code “Class [i] [c]. members [m]. eng=0;”.

In addition, the item “multidimensional hierarchy” indicates the hierarchy of the structure. For example, the structure “Class [i] [c]” is a two-dimensional structure. Therefore, a value of the item “multidimensional hierarchy” corresponding to each code is a value “2”.

(S46: Structure Analysis Processing)

FIG. 14 is a diagram of flow chart explaining the structure analysis processing of the process S46 which is explained in FIG. 12.

S51: The structure analysis module 123 carries out the process S52-S59 for a code counter of the target loop processing included in the loop statement detection table 131. In other words, according to the structure detection table 132 in FIG. 13, the structure analysis module 123 carries out the process S52-S59 about the NO “7” and the NO “8”.

S52: The structure analysis module 123 carries out the process S53-S58 of times of the number of the multidimensional hierarchies that the structure detection table 132 has. In other words, according to the structure detection table 132 in FIG. 13, the structure analysis module 123 performs two times of processing in the process S53-S58 for each of the NO.

S53: The structure analysis module 123 reads the information of the item “loop constitution” with reference to loop statement detection table 131.

S54: The structure analysis module 123 acquires the subscript of the bottom layer of the structure among the item “loop constitution” (S1-S3) in the structure detection table 132. According to the structure detection table 132 in FIG. 13, the structure analysis module 123 acquires the subscript “m” in the value “members [m]”.

S55: The structure analysis module 123 adds the letter “=” to the subscript and searches a letter “subscript=” from the target loop processing of the item “loop constitution” in the loop statement detection table 131. In other words, the structure analysis module 123 searches the letter “m=”. In addition, the letter “m=” includes a letter “m++” or a letter “m−−”.

S56: The structure analysis module 123 judges whether the letter “subscript=” is detected.

S57: When the letter is not detected (No of S56), it indicates that a value of variable “m” does not change in the target loop processing. Therefore, the structure analysis module 123 memorizes a value “0 (Constant: uniformity)” to a pointer flag in the optimization structure table 133. And the structure analysis module 123 moves to the process S53 and reads information of the next high-ranking hierarchy.

S58: On the other hand, when the letter “subscript=” is detected (Yes of S56), it indicates that a value of variable “m” changes in the target loop processing. Therefore, the structure analysis module 123 memorizes a value “1 (Variable: change)” to the pointer flag in the optimization structure table 133.

According to the example of loop statement detection table 131 in FIG. 11, the third loop processing “Ip3” includes the letter “m++”. Therefore, the structure analysis module 123 memorizes the value “1” to the pointer flag of hierarchy S2 corresponding to the value “members [m]” in the optimization structure table 133.

S59: The structure analysis module 123 moves to the process S60 when the loop processing of times of the number of the multidimensional hierarchies are performed.

Therefore, the structure analysis module 123 searches a letter “c=”. The third loop processing “Ip3” does not include the letter “c++”. Similarly, the structure analysis module 123 searches a letter “i=”, but the third loop processing “Ip3” does not include the letter “i++”. Therefore, the structure analysis module 123 memorizes the value “0” to the pointer flag of hierarchy S1 corresponding to value “Class [i] [c]” in the optimization structure table 133.

S60: The structure analysis module 123 finishes the processing when the structure analysis module 123 performs loop processing of times of the value of the code counter. According to the example of structure detection table 132 in FIG. 13, the structure analysis module 123 carries out a similar step about the NO “8” in the structure detection table 132 and sets the similar pointer flag.

(Optimization Structure Table 133)

FIG. 15 is a diagram indicating an example of the optimization structure table 133. The optimization structure table 133 has, for example, the item “NO” and an item “pointer flag”. The item “NO” was illustrated by the loop statement detection table 131 in FIG. 11.

The item “pointer flag” is a flag indicating whether the address of the structure of each hierarchy (S1-S3) changes for every target loop processing. When the pointer flag is value “0 (Constant)”, the item “pointer flag” indicates that the address of the structure of the hierarchy concerned does not change at every loop processing. On the other hand, when the pointer flag is value “1 (Variable)”, the item “pointer flag” indicates that the address of the structure of the hierarchy concerned changes at every loop processing.

As mentioned above in the process S58 in FIG. 14, because the value “Class [i] [c]” does not change at every third loop processing “Ip3”, the item “S1” has value “0 (Constant)”. In addition, because the value “members [m]” changes at every third loop processing “Ip3”, the item “S2” has value “1 (Variable)”.

(Process S22)

FIG. 16 is a diagram of flow chart explaining processing in the process S22 which is explained in FIG. 9.

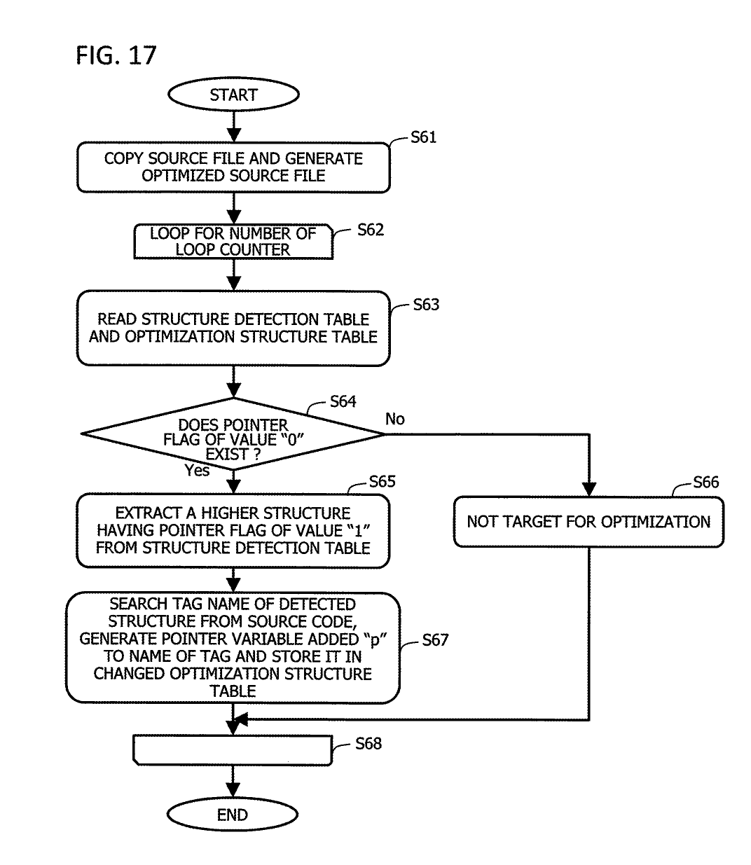

S101: The code correction module 124 detects the type of the structure which is detected with reference to the optimization structure table 133 and decides the name of the pointer variable. And the code correction module 124 memorizes the name of the pointer variable that is decided to the changed optimization structure table 134. The details of the processing in the process S101 will be mentioned later according to a flow chart in FIG. 17.

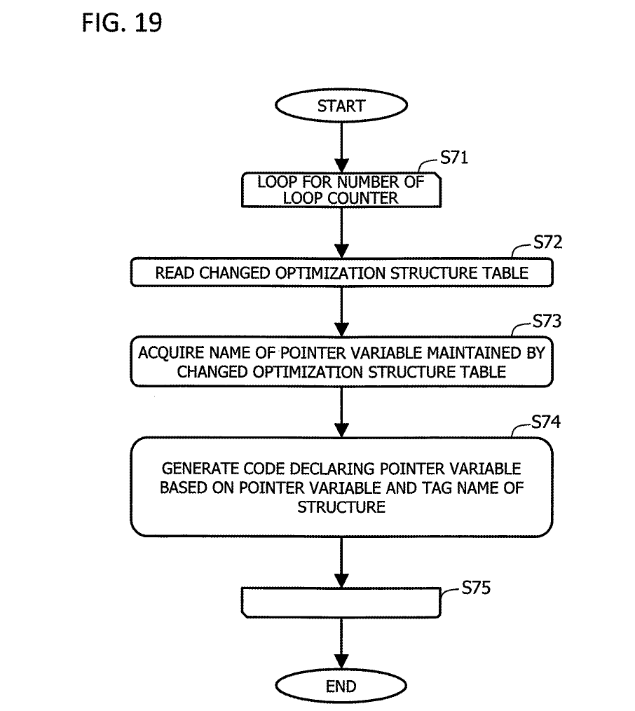

S102: The code correction module 124 acquires the name of the pointer variable with reference to the changed optimization structure table 134, and inserts a code declaring the pointer variable in the optimized source file “cb”. The details of the processing in the process S102 will be mentioned later according to a flow chart in FIG. 19.

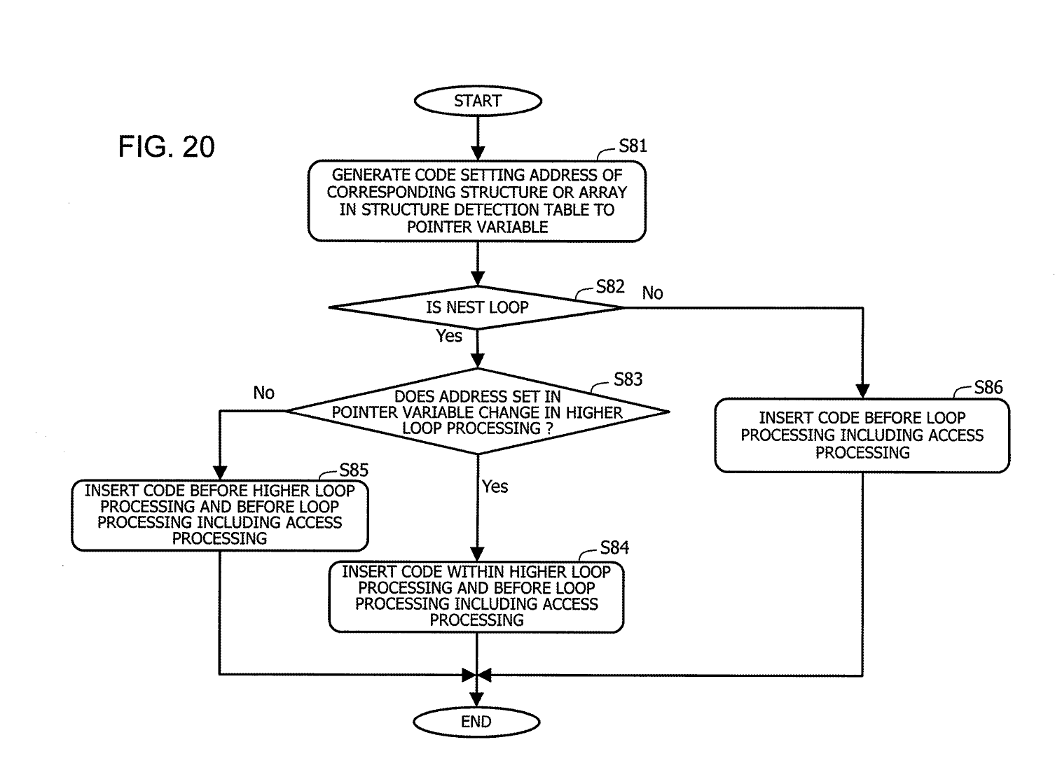

S103: The code correction module 124 inserts a code setting the address of the structure in a pointer variable before the target loop processing in the optimized source file “cb”. The details of the processing in the process S103 will be mentioned later according to a flow chart in FIG. 20.

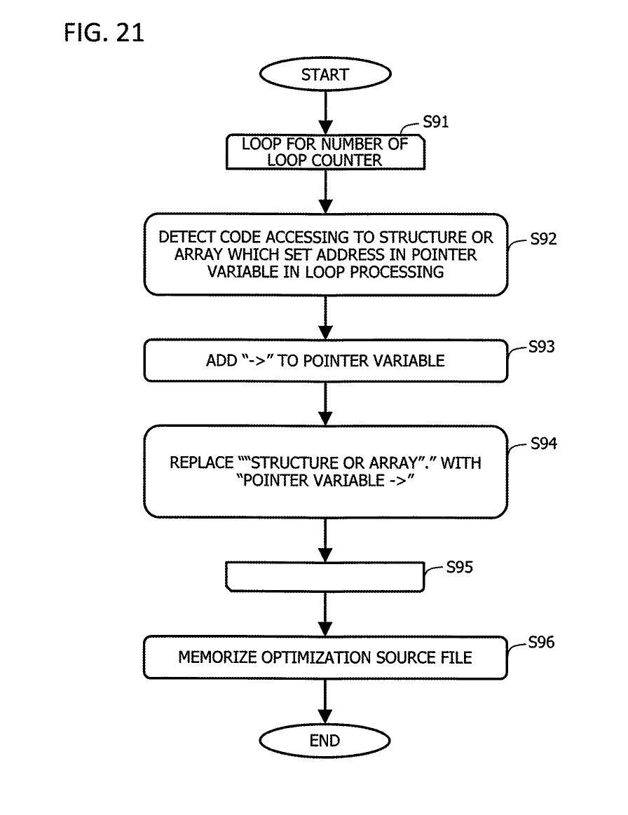

S104: The code correction module 124 replaces a code accessing a member in the target loop processing in the optimized source file “cb” with a code to access based on the pointer variable. The details of the processing in the process S104 will be mentioned later according to a flow chart in FIG. 21.

(Processing of Process S101)

FIG. 17 is a diagram of flow chart explaining the details of the processing in the process S101 which is explained in FIG. 16.

S61: The code correction module 124 copies the source file “ca” and generates the optimized source file “cb”.

S62: The code correction module 124 carries out the process S63-S67 for the code counter in the loop statement detection table 131. In other words, the code correction module 124 carries out the process S63-S67 for the NO “7” and the NO “8” in the structure detection table 132.

S63: The code correction module 124 reads the structure detection table 132 and the optimization structure table 133.

S64: The code correction module 124 searches whether there is a hierarchy that the pointer flag is value “0 (Constant)” with reference to the optimization structure table 133.

S65: When the hierarchy that the pointer flag is the value “0” is detected (Yes of S64), the code correction module 124 extracts the structure (or array) which is the higher structure in the hierarchy that the pointer flag is the value “1 (Variable)” and is a structure in the hierarchy that the pointer flag is the value “0”.

According to the optimization structure table 133 in FIG. 15, a pointer flag of the hierarchy “S1” is value “0”, and a pointer flag of the hierarchy “S2” is value “1”. Therefore, the code correction module 124 extracts value “Class [i] [c]” indicating the structure of the hierarchy “S1” with reference to the structure detection table 132.

In this way, the code correction module 124 judges whether there is the address of the structure (array) of the hierarchy that the pointer flag is value “0 (Constant)”. Thereby, the code correction module 124 extracts the address of the structure (or array) (in this example an address of the value “Class [i] [c]”) that an address does not change in the loop processing “Ip3”. In other words, it is possible that the code correction module 124 appropriately detects an address of the structure or array that an address does not change at every loop processing “Ip3”.

S66: On the other hand, when a hierarchy that the pointer flag indicates value “0” is not detected (No of S64), it indicates that the address of the structure (or array) that an address does not change does not exist in the loop processing “Ip3”. Therefore, the code correction module 124 does not target the code of the target NO to the optimization.

S67: The code correction module 124 searches the type of the structure which is detected from the source code. The code correction module 124 acquires the type (tag name) of the structure by detecting a code declaring the variable of the structure which is detected from the source code. And the code correction module 124 generates the pointer variable which is added “_p” to the tag name that is acquired and memorizes it to the changed optimization structure table 134.

According to the source code in FIG. 1, the code declaring of value “Class [i] [c]” is a code “struct members Class [2] [8];”. Therefore, the code correction module 124 detects that a type of the value “Class [i] [c]” is a members type and generates the name of the pointer variable which is added “_p” to the name “members” of the type that is detected. The code correction module 124 generates the name “members_p” of the pointer variable and updates it to the changed optimization structure table 134.

S68: The code correction module 124 finishes processing of process S101 when the code correction module 124 performs loop processing for the value of the code counter.

(Changed Optimization Structure Table 134)

FIG. 18 is a diagram indicating an example of the changed optimization structure table 134. The changed optimization structure table 134, has, as same as the structure detection table 132 (referring to FIG. 13), an item “NO”, an item “loop constitution” and an item “multidimensional hierarchy”, for example.

The changed optimization structure table 134 depicted in FIG. 18 has the name of the pointer variable for the structure detection table 132 in FIG. 13. As explained in the process S67 of the flow chart in FIG. 17, the changed optimization structure table 134 has name “members_p” of the pointer variable in substitution for the value “Class [i] [c]”.

(Processing of Process S102)

FIG. 19 is a diagram of flow chart explaining the details of the processing of process S102 which is explained in FIG. 16.

S71: The code correction module 124 carries out the process S72-S74 for a code counter in the loop statement detection table 131.

S72: The code correction module 124 reads the changed optimization structure table 134.

S73: The code correction module 124 acquires the pointer variable name that the changed optimization structure table 134 has. In other words, the code correction module 124 acquires the name “members_p” of the pointer variable.

S74: The code correction module 124 generates a code cd11 declaring the pointer variable based on the pointer variable in the changed optimization structure table 134 and the tag name of the structure and writes it in the optimized source file “cb”.

Especially, the code correction module 124 generates the tag name which is added “_t” to the name “members” of the type that is detected. And the code correction module 124 generates the code “members_t *restrict members_p;” cd11 based on the ““tag name” *restrict “pointer variable”” and write it in the optimized source file “cb”.

S75: The code correction module 124 finishes processing of process S102 when the code correction module 124 performs the loop processing for the value of the code counter.

(Processing of Process S103)

FIG. 20 is a diagram of flow chart explaining the details of the processing of process S103 which is explained in FIG. 16.

S81: The code correction module 124 generates code cd12 setting a corresponding address of the structure or the array in the structure detection table 132 to the generated pointer variable.

According to the optimization structure table 133 in FIG. 15, the code correction module 124 extracts a variable name “Class [i] [c]” of the structure of higher hierarchy “S1” than the hierarchy “S2”. And the code correction module 124 generates the code cd12 setting an address of the structure “Class [i] [c]” which is extracted in the pointer variable “members_p”.

S82: The code correction module 124 judges whether the loop processing having the access processing is the loop processing included in the nest loop.

S83: When the loop processing is included in the nest loop (Yes of S82), the code correction module 124 judges whether or not the address that is set into the pointer variable changes in a higher loop processing. In other words, the code correction module 124 judges whether or not the address “& Class [i] [c]” changes in the second loop processing “Ip2”.

S84: When the address changes in the higher loop processing (Yes of S83), the code correction module 124 inserts the code cd12 before the loop processing including the access processing and within high-ranking loop processing.

According to the source code in FIG. 1, the address “& Class [i] [c]” changes in the second loop processing “Ip2”. Therefore, as represented by FIG. 3, the code correction module 124 inserts the code cd12 before the third loop processing “Ip3” including the access processing, and within the second loop processing “Ip2”.

S85: On the other hand, when the address does not change in the higher loop processing (No of S83), the code correction module 124 inserts the code cd12 before the loop processing including the access processing and before the high-ranking loop processing.

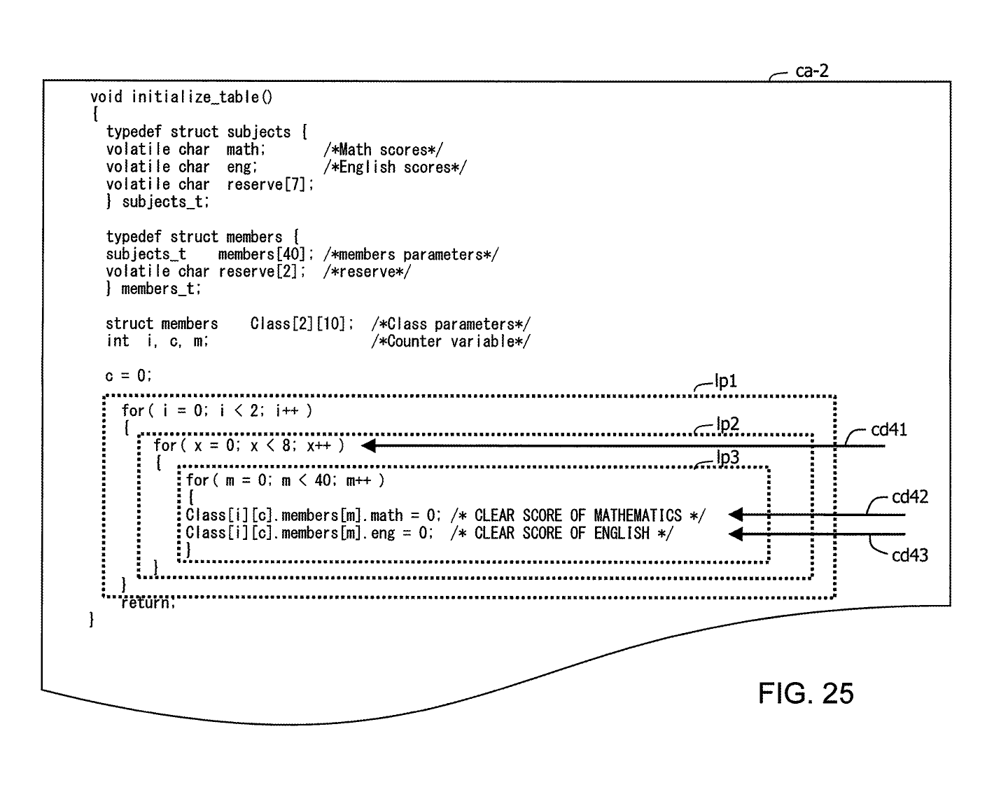

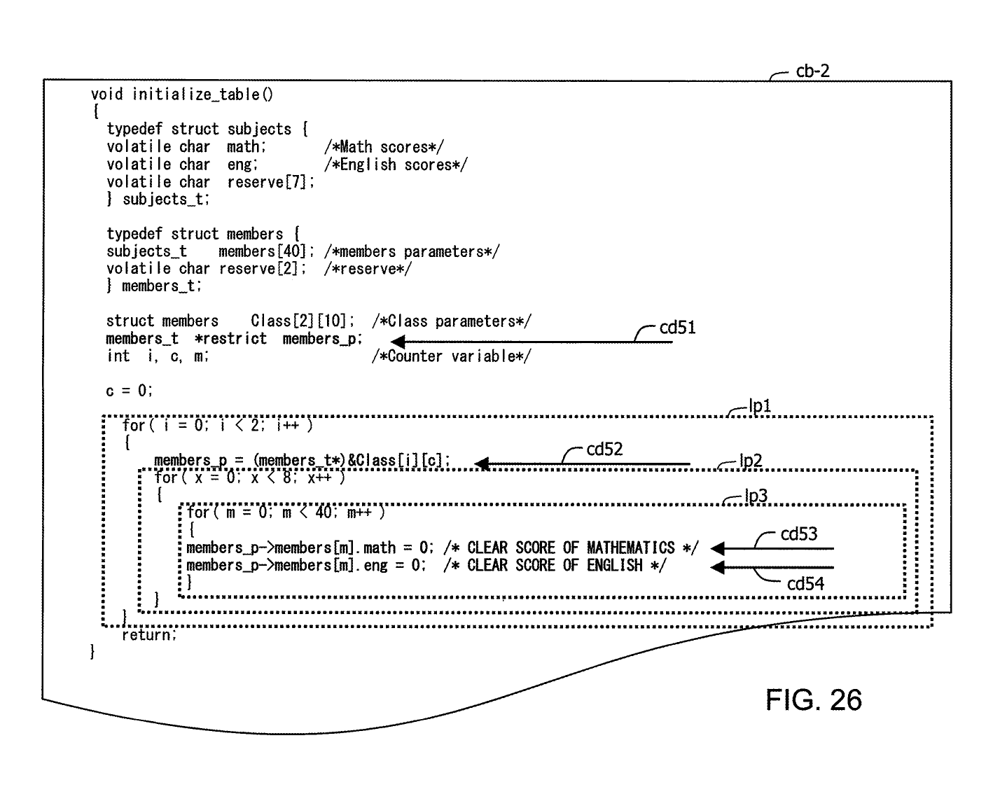

For example, the code correction module 124 inserts the code cd12 before second and third loop processing “Ip2”, “Ip3” when the address “& Class [i] [c]” does not change in the second loop processing “Ip2”. The detail will be mentioned later according to FIG. 25, FIG. 26.

There is little loop number of times of the first loop processing “Ip1” for the loop number of times of the second loop processing “Ip2”. Therefore, by moving the code cd12 which performs calculation process of the address outside the second loop processing “Ip2”, it is possible to reduce the number of times of calculation process of the address p1-p14 more.

In this way, the code correction module 124, when the loop processing is included in different loop processing and an address of the structure or the array changes in the different loop processing, inserts the first and second codes “cd11”, “cd12” before the loop processing and within the different loop processing. In addition, the code correction module 124, when the address does not change in the different loop processing, inserts the first and second code “cd11”, “cd12” before the loop processing and the different loop processing. Thereby, it is possible that the code correction module 124 more reduces a number for the cycle of the program corresponding to the source code after the optimization.

S86: On the other hand, when the loop processing is not included in the nest loop (No of S82), the code correction module 124 inserts the code which is generated before the loop processing including the access processing. In other words, the code correction module 124 inserts the code cd12 before third loop processing “Ip3” including the access processing.

(Processing of Process S104)

FIG. 21 is a diagram of flow chart explaining the details of the processing of process S104 which is explained in FIG. 16.

S91: The code correction module 124 carries out the process S92-S94 for a code counter in the loop statement detection table 131.

S92: The code correction module 124 detects a code accessing the structure or array which set an address in a pointer variable in the target loop processing from the optimized source code. In other words, the code correction module 124 detects a code of the access processing for the replacement target. Especially, the code correction module 124 detects the code “Class [i] [c]. members [m]. math=0;” about the NO “7”. In addition, the code correction module 124 detects the code “Class [i] [c]. members [m]. eng=0;” about the NO “8”.

S93: The code correction module 124 adds a letter “->” to the generated pointer variable. In other words, the code correction module 124 generates the code “p_members->”.

S94: The code correction module 124 replaces a letter ““value of the structure or the array”.” with code “p_members->” about the code which is detected in the optimized source file “cb” in the process S92.

S95: When the code correction module 124 performs loop processing for the value of the code counter, the code correction module 124 moves in the process S96.

S96: The code correction module 124 memorizes the optimized source file “cb” which is revised to the auxiliary memory 111 etc.

[Example 1 of Other Source Code]

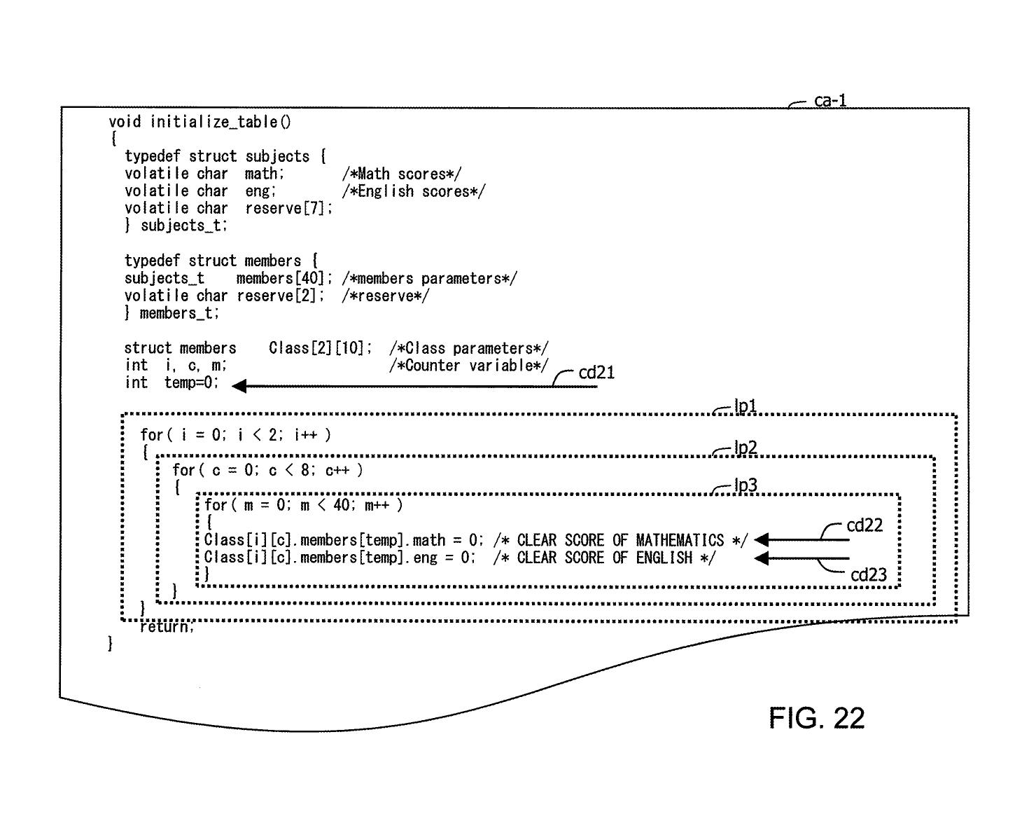

FIG. 22 is a diagram indicating the examples of source file ca-1 including the source code for the different optimization target. FIG. 1 represents a case that an address of the member “Class [i] [c]. members [m]. math”, “Class [i] [c]. members [m]. eng” for access target changes every one of third loop processing “Ip3”. In contrast, the source file “ca-1” in FIG. 22 represents the example that the address of the member for the access target does not change every one of the third loop processing “Ip3”.

In FIG. 22, the code cd21-cd23 are different from the source code in FIG. 1. The code cd21 indicates processing to set value “0” in a variable “temp”. In an example of FIG. 22, a value of variable “temp” is fixed value “0”. Therefore, at every third loop processing Ip3, an address of value “members [temp]” does not change. It is similar about the code cd23.

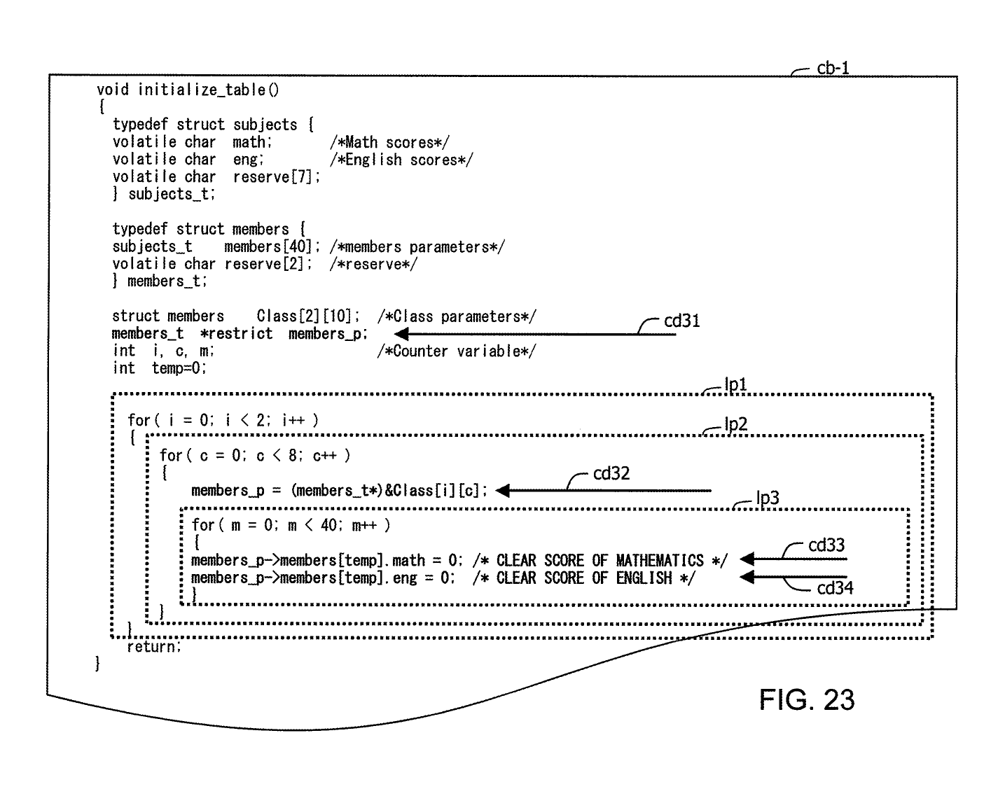

FIG. 23 indicates an example of the source file cb-1 after an information processing device according to the embodiment optimized the source file “ca-1” depicted in FIG. 22. The information processing device 100 inserts the code cd31, cd32 in the source code, and replaces the code cd22, cd23 (referring to FIG. 22) with the code cd33, cd34 together. The code cd31, cd32 are similar to an example of FIG. 3.

The code cd33, cd34 are codes accessing the member “members [temp]. math”, “members [temp]. eng” based on the pointer variable “members_p”. As same as an example of FIG. 3, according to the source code depicted in FIG. 23, the code cd33, cd34 do not have a calculation process of the address p1-p14 of variable “Class [i] [c]”. Therefore, it is possible to omit the calculation process of address p1-p14 in the third loop processing Ip3, and to decrease the calculation processing of address largely. Thereby, it is possible reduce the cycle needed for the execution of the program.

In addition, when the address of the member for the access target does not change every one of the third loop processing Ip3, the information processing device 100 may move the calculation process of the address p21-p24 of the higher subject structure of the member “math”, outside the third loop processing “Ip3”.

In this case, the information processing device 100 inserts the code “subject_p=(subject_t*) & Class [i] [c]. members [temp];” as the code cd32. And the information processing device 100 replaces the code cd22 (referring to FIG. 22) with a code “subject_p->math=0” and replaces the code cd23 (referring to FIG. 22) with the code “subject_p->eng=0”.

In this case, it is possible to omit a calculation process of the address p21-p24 in the third loop processing Ip3 and to restrain the calculation processing of the address.

(Cycle Number)

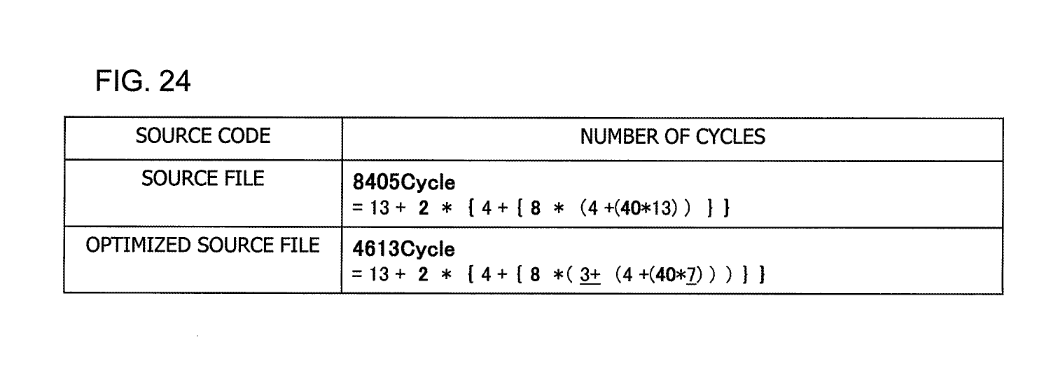

FIG. 24 is a diagram representing the number of cycles needed by the execution of the program corresponding to the source file ca-1 (referring to FIG. 23) and the number of cycles needed by the execution of the program corresponding to the optimized source file cb-1 (referring to FIG. 23).

As illustrated in FIG. 24, the number of cycles needed for the execution of the program corresponding to the source file “ca” depicted in FIG. 22 is in a value “8405 Cycle” which is calculated according an expression “13+2*{4+{8*(4+(40*13))}}” for example. On the other hand, the number of cycles needed for the execution of the program corresponding to the source file “ca” after the optimization depicted in FIG. 23 is in a value “4613 Cycle” which is calculated according to the expression “13+2*{4+{8*(3+(4+(40*7)))}}”.

In this way, the number of cycles largely decreases when the address of the structure having a member in the loop processing Ip3 including the access processing does not change.

[Example 2 of the Source Code]

FIG. 25 is a diagram indicating the examples of source file ca-2 including the source code for the different optimization target. FIG. 1 represents an example when the address (& Class [i] [c]) of value “Class [i] [c]” changes at every second loop processing “Ip2” in the process S83 of the flow chart in FIG. 20. In contrast, FIG. 25 exemplifies the case that the address “& Class [i] [c]” does not change every one of the second loop processing Ip2.

According to the code cd41 of the source code in FIG. 25, the counter variable of the second loop processing Ip2 is a variable “x”. Therefore, address “& Class [i] [c]” does not change because the value “c” does not change at every second loop processing Ip2.

FIG. 26 represents an example of source file “cb-2” after the information processing device 100 according to the embodiment optimized the source file “ca-2” depicted in FIG. 25. The information processing device 100 inserts the code cd51, cd52 in the source code and replaces the code cd42, cd43 (referring to FIG. 25) with the code cd53, cd54 together. The code cd51-cd54 are similar to the code cd11-cd14 depicted in FIG. 3.

According to the example of FIG. 26, the information processing device 100 inserts the code cd52 which sets the address “& Class [i] [c]” at the pointer variable before the second, third loop processing Ip2, Ip3. In other words, the information processing device 100 moves the calculation processing of the address p1-p14 to outside the second loop processing Ip2 in addition to the third loop processing Ip3.

The loop number of times of first loop processing Ip1 is smaller than the loop number of times of second loop processing Ip2. Therefore, it is possible to reduce the number of times of calculation process of the address more by moving the code cd52 which performs the calculation process of the address outside the second loop processing Ip2. Thereby, the code correction module 124 reduces a number of the cycles of the program corresponding to the source code after the optimization more.

[Example 3 of the Source Code]

The above embodiments are exemplified a case to omit the address calculation of the structure which has a member. The optimization processing according to the embodiment is applicable for the array which has a plurality of members.

FIG. 27 is a diagram indicating the example of the source file “ca-3” including the source code for the different optimization target. FIG. 1 represents an example case that the source file “ca” has the processing to access the member of the structure. In contrast, FIG. 27 exemplifies the source file “ca-3” having the processing to access the member in the array.

A code cd61 depicted in FIG. 27 indicates processing to set the value “0” to the member of two-dimensional array “members [i] [c]”. The processing of code cd61 has the calculation process of the address of the value “members [i] [0]”

FIG. 28 illustrates an example of source file “cb-3” after the information processing device according to the embodiment optimized the source file “ca-3” depicted in FIG. 27. The information processing device 100 inserts codes cd71, cd72 in the source code, and replaces a code cd61 with a code cd73 together.

The code cd71 indicates processing to declare the pointer variable “plist”, and the code cd72 indicates processing to set an address of value “members [i] [0]” to the pointer variable “plist”. In addition, the code cd73 indicates a code accessing to the member “members [i] [c]” based on the pointer variable “plist”.

According to the source code depicted in FIG. 28, it is possible to omit the calculation process of the address of value “members [i] [0]” at every execution of the code cd73. Because the processing amount for the program run time largely decreases by controlling the outbreak of the calculation process of the address in the loop processing to perform repeatedly, it is possible to largely reduce the number of cycles needed to the execution of the program. In this way, the optimization processing according to the embodiment is applicable for the array having a member.

In addition, the “for statement” is exemplified as the loop processing in the embodiment. However, it is not a thing limited to this example. The loop processing may include the different loop processing of “while statement” or “do statement”. The optimization processing according to the embodiment is applicable for the loop processing except the “for statement”.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optimization device of a program, the optimization device comprising:
a memory to store a source code; and
a processor that detects a structure or an array having a member targeted for access in a loop processing from the source code,
inserts a first code declaring a pointer variable and a second code that sets an address of the structure or the array in the pointer variable before the loop processing of the source code, and
replaces a code which accesses the member in the loop processing with a third code accessing the member based on the pointer variable.

2. The optimization device according to claim 1, wherein the processor inserts the second code that sets the address of the structure or the array that the address does not change at every loop processing in the pointer variable.

3. The optimization device according to claim 1, wherein the processor inserts the first and second codes before the loop processing and within another loop processing when the loop processing is included in another loop processing and the address of the structure or the array changes in another loop processing, and inserts the first and second codes before the loop processing and another loop processing when the loop processing is included in another loop processing and the address of the structure or the array does not change in another loop processing.

4. The optimization device according to claim 1, wherein the processor detects the structure or the array having the member that is targeted for access in the loop processing of which the number of times of the loop is more than a specified value.

5. The optimization device according to claim 4, wherein the number of times of the loop is a product with a first loop number of times of the loop processing and a second loop number of times of another loop processing, when the loop processing is included in another loop processing.

6. The optimization device according to claim 1, wherein the structure includes a multidimensional structure.

7. The optimization device according to claim 1, wherein the array includes a two dimensional array.

8. A non-transitory computer readable storage medium storing therein an optimization program that causes a computer to execute a process, the process comprising:
detecting a structure or an array having a member targeted for access in a loop processing from a source code;
inserting a first code declaring a pointer variable and a second code that sets an address of the structure or the array in the pointer variable before the loop processing of the source code; and
replacing a code which accesses the member in the loop processing with a third code accessing the member based on the pointer variable.

9. The storage medium according to claim 8, wherein the inserting comprises inserting the second code that sets the address of the structure or the array that the address does not change at every loop processing in the pointer variable.

10. The storage medium according to claim 8, wherein the inserting comprises:
first inserting the first and second codes before the loop processing and within another loop processing when the loop processing is included in another loop processing and the address of the structure or the array changes in another loop processing; and
second inserting the first and second codes before the loop processing and another loop processing when the loop processing is included in another loop processing and the address of the structure or the array does not change in another loop processing.

11. The storage medium according to claim 8, wherein the detecting comprises detecting the structure or the array having the member that is targeted for access in the loop processing of which the number of times of the loop is more than a specified value.

12. The storage medium according to claim 11, wherein the number of times of the loop is a product with a first loop number of times of the loop processing and a second loop number of times of another loop processing, when the loop processing is included in another loop processing.

13. The storage medium according to claim 8, wherein the structure includes a multidimensional structure.

14. The storage medium according to claim 8, wherein the array includes a two dimensional array.

15. A method for generating of an optimized program, the method comprising:
detecting, by a processor, a structure or an array having a member targeted for access in a loop processing from a source code;
inserting, by a processor, a first code declaring a pointer variable and a second code that sets an address of the structure or the array in the pointer variable before the loop processing of the source code; and
replacing, by a processor, a code which accesses the member in the loop processing with a third code accessing the member based on the pointer variable.

16. The method according to claim 15, wherein the inserting comprises inserting the second code that sets the address of the structure or the array that the address does not change at every loop processing in the pointer variable.

17. The method according to claim 15, wherein the inserting comprises:
first inserting the first and second codes before the loop processing and within another loop processing when the loop processing is included in another loop processing and the address of the structure or the array changes in another loop processing; and
second inserting the first and second codes before the loop processing and another loop processing when the loop processing is included in another loop processing and the address of the structure or the array does not change in another loop processing.

18. The method according to claim 15, wherein the detecting comprises detecting the structure or the array having the member that is targeted for access in the loop processing of which the number of times of the loop is more than a specified value.

19. The method according to claim 18, wherein the number of times of the loop is a product with a first loop number of times of the loop processing and a second loop number of times of another loop processing, when the loop processing is included in another loop processing.

20. The method according to claim 15, wherein the structure includes a multidimensional structure.
